(19) United States
(12) Patent Application Publication
(10) Pub. No.: US 2026/0330738 A1
(43) Pub. Date: Oct. 22, 2026

(54) SYSTEM AND METHOD FOR CREATING AND TRANSMITTING ANIMATIONS

(71) Applicant: FD IP & LICENSING LLC, Los Angeles, CA (US)

(72) Inventors: Chia-Hsun CHUANG, Los Angeles, CA (US); Brandon FAYETTE, Los Angeles, CA (US); Gene REDDICK, San Francisco, CA (US)

(21) Appl. No.: 19/646,027

(22) Filed: Apr. 13, 2026

Related U.S. Application Data
(60) Provisional application No. 63/789,547, filed on Apr. 16, 2025.

(51) Int. Cl. G06T 13/40; G06T 17/00; G06T 19/00

(52) U.S. Cl. CPC G06T 13/40; G06T 17/00; G06T 19/00; G06T 2200/24; G06T 2219/024

(57) ABSTRACT

A method includes receiving, by a mobile device, a selection of a media type or a source media; receiving, by the mobile device, a prompt; and receiving, by the mobile device, a three-dimensional animation of the selection based on the prompt in response to providing the prompt and selection to one or more generative artificial intelligence (GAI) models.

### FIELD OF THE DISCLOSURE

The present disclosure relates generally to generating and transmitting animations and, more particularly, to a unitary tool for generating and sharing animations from a mobile device.

### BACKGROUND OF THE DISCLOSURE

Creating animations in the film-making industry is a complex and multi-step process that involves several stages, including concept development, modeling, texturing, rigging, animation, rendering, and post-production. Initially, artists and designers develop the concept and storyboard, outlining the visual and narrative elements of the animation. This is followed by the modeling phase, where three-dimensional (3D) models of characters, objects, and environments are created using specialized software. Texturing adds surface details, such as colors and patterns, to these models. Rigging involves creating a skeletal structure for the models, allowing them to be animated. The animation phase brings these models to life by defining their movements and actions. Finally, rendering converts the 3D models and animations into two-dimensional (2D) images or frames, which are then compiled and edited in post-production to create the final animation.

The process of creating animations is time-consuming, often taking several weeks to months, depending on the complexity and scale of the project. One of the primary reasons for this extended timeline is the high level of detail and precision required at each stage. For instance, modeling and texturing need to be meticulously crafted to ensure realism and consistency. Rigging and animation require careful attention to movement and physics to make the characters' actions believable. Rendering is particularly resource-intensive, as it involves processing vast amounts of data to produce high-quality images. Additionally, the iterative nature of the process, where feedback and revisions are continuously incorporated, further extends the timeline. The collaboration between various teams, including artists, animators, and technical experts, also adds to the complexity and duration of the project.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of an example animation tool.

FIG. 2 is a graphical user interface (GUI) of an example start menu provided by the animation tool.

FIG. 3 is an example GUI for generating media provided by the animation tool.

FIG. 4 is a flowchart example of GUIs for generating an image.

FIG. 5 is an example GUI for rendering image.

FIG. 6 is an example GUI for rendering a three-dimensional (3D) model.

FIGS. 7-8 are example GUIs for rigging a 3D model.

FIG. 9 is an example GUI for rendering a rigged 3D model.

FIG. 10 is a flowchart example of GUIs for animating a 3D model.

FIG. 11 is an example GUI of an animated 3D model.

FIG. 12 is an example masking GUI.

FIG. 13 depicts flowchart examples for generating 3D models of portions of an image.

FIG. 14 is an example mesh GUI.

FIG. 15 is another example of a GUI for rendering a 3D model.

FIG. 16 is an example of blocking operations.

FIG. 17 is an example of replacement operations.

FIG. 18 is a flowchart example of GUIs implementing scanning of a an object.

FIG. 19 is an example of a virtual environment generated from a physical environment with scanning operations.

FIG. 20 is an example GUI for importing a screenplay.

FIG. 21 is an example of GUIs for selecting features of a screenplay for a video scene generation.

FIG. 22 is an example GUI for video scene editing.

FIG. 23 is an example GUI for implementing sketch editing operations.

FIG. 24 is a flowchart of an example method for generating and transmitting animated 3D models.

FIG. 25 is a flowchart of an example method for creating high-resolution 3D models.

FIG. 26 is a flowchart of an example method for replacing portions of an image.

FIG. 27 is a flowchart of an example method for generating and editing a video scene.

FIG. 28 is a flowchart of an example method for generating multi-media.

FIG. 29 is a block diagram of a computer system for implementing the animation tool.

### DETAILED DESCRIPTION

Embodiments of the present disclosure will now be described in detail with reference to the accompanying Figures. Like elements in the various Figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to generating and transmitting animations and, more particularly, to a unitary tool for generating and sharing animations from a mobile device.

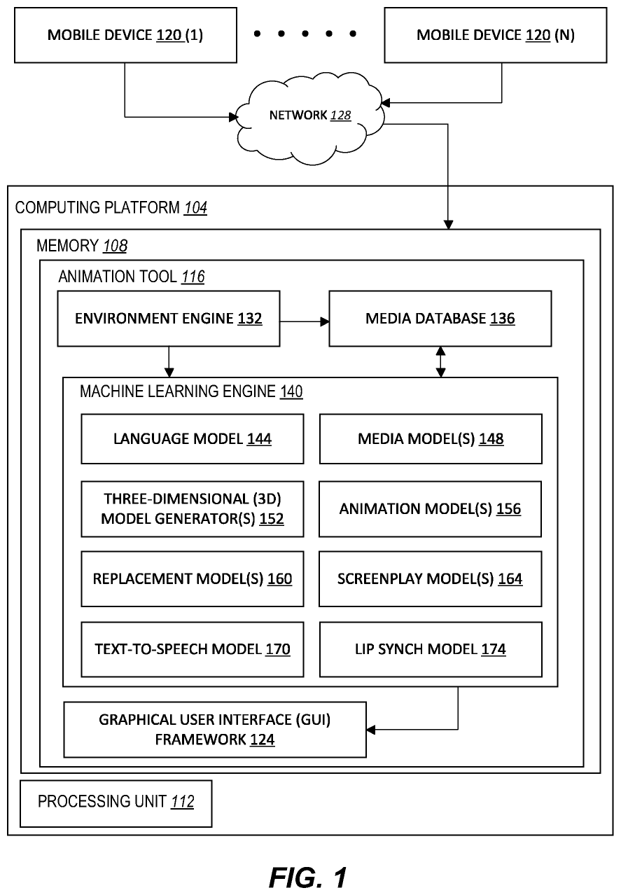

FIG. 1 illustrates a block diagram of an example web-based animation system 100. The animation system 100 can include a computing platform 104 that further includes a memory 108 for storing machine-readable instructions and data. The computing platform 104 can further include a processing unit 112 for accessing the memory 108 and executing the machine-readable instructions. The memory represents a non-transitory machine-readable memory (or other medium), such as random access memory (RAM), a solid state drive, a hard disk drive or a combination thereof. The processing unit 112 can be implemented as one or more processor cores. The computing platform 104 can further include a network interface (not shown), such as a network interface card configured to communicate with other components of the system 100.

The computing platform 104 can be implemented in a computing cloud. In such a situation, features of the computing platform 104, such as the processing unit 112, the network interface, and the memory 108 can be representative of a single instance of hardware or multiple instances of hardware with applications executing across the multiple instances (e.g., distributed) of hardware (e.g., computers, routers, memory, processors, or a combination thereof). Alternatively, the computing platform 104 can be implemented on a single dedicated server or workstation. Furthermore, in some examples the computing platform 104 can be employed to implement other components of the animation system 100 in a similar manner. However, for purposes of simplification of explanation, only the details of the computing platform 104 are shown.

The memory 108 can further include an animation tool 116 to allow clients to request various animation services from the animation tool 116. That is, the animation tool 116 can receive a request to generate an animated three-dimensional (3D) model from a client operating on a mobile device 120. In response, the animation tool 116 can generate and provide the animated 3D model to the mobile device 120. In another example, the mobile device 120 is a first mobile device 120 (1) that requests the 3D animated model. In response to generating the 3D animated model, the animation tool 116 can also provide to one or more mobile devices 120 (N) other than the first mobile device 120 (1), where N is an integer greater than 1. Thus, the 3D animated model can be shared amongst various mobile devices 120 to view and edit the 3D animated model in various virtual environments.

The animation tool 116 is further equipped to rapidly generate 3D animated models in response to receiving a request from a client of a mobile device 120, such that the animation tool 116 can be deployed for rapidly prototyping 3D animated models. These 3D animated models can be generated using only, for example, text input provided to the animation tool 112. As further explained, the text input can be employed in conjunction with various models and media to generate the 3D animated models in an iterative manner.

The animation tool 116 can further include modules that execute specific operations to assist with these tasks. Specifically, the animation tool 116 can include a graphical user interface (GUI) framework 124, which can generate GUIs that are provided to remote computers. For example, the GUI framework 124 can generate and provide a GUI with graphical elements to a client operating on a remote computer, such as the mobile devices 120. Further, the GUI framework 120 can receive data from the client in response to client interaction with functionality of the GUI defined by the GUI framework 120.

Moreover, the GUI framework 120 can provide GUI functionality to clients of the animation tool 116 to facilitate generation of a 3D animated model. For example, the GUI framework 120 can provide a GUI to a mobile device 120 at network 128. The network 128 can be an Internet Protocol version 6 (IPV6) network, 5G broadband network, a 4G Long Term Evolution (LTE) network, or local area network (LAN) compatible with Institute of Electrical and Electronics Engineers (IEEE) 802 Standards. In other examples, the mobile devices 120 can have a wired connection to the computing platform 104. Thus, a mobile device 120 can provide data to the animation tool 116 to generate a 3D animated model. Further, generation of a 3D animated model can involve more than text input from a mobile device 120. For example, an iterative process of generation can occur where text input is used to generate an image, the image is employed to generate a 3D model, and the 3D model is employed to generate an animation of the 3D model. At each step or iteration, the text input or GUI framework 124 can be employed to adjust or alter the generated media. Once the animated 3D model is generated by the animation tool 112, the 3D animated model can be placed within a virtual environment, which can be rendered by the GUI framework 124 onto a mobile device 120. Moreover, the 3D animated model can be generated on a first mobile device 120 (1) and provided to a virtual environment on a second mobile device 120 (2). Thus, 3D animated models can be prototyped in a first location associated with the first mobile device 120 (1) and rendered for view or editing in a virtual environment at a second location associated with the second mobile device 120 (2).

To assist with these tasks, the animation tool 112 includes an environment engine 132, which is configured to generate or render 3D environments for a GUI. The 3D environments can include or receive 3D animated models and be provided to a mobile device 120 over the network 128. The environment engine 132 can also receive environments and 3D animated models from a media database 136. The media database 136 can store previously generated 3D animated models, 3D models, images, video, and previously generated environments for future use by the animation tool 112.

For generation of animated 3D models, the animation tool 112 can employ a machine learning engine 140. The machine learning (ML) engine 140 can include a variety of ML models, such as generative artificial intelligence (GAI) models. The ML models of the ML engine 140 includes a language model 144, which can be a large language model (LLM). The language model 144 can receive text input from a mobile device 120 (e.g., via the GUI framework 124), which can be referred to herein as a prompt. The language model 144 can further update the prompt to be more specific and provide improved detail for another model. For example, the ML engine 140 can further include a media model 148 capable of generating media based on a prompt. The media model 148 can be selected from a variety of media models capable of generating media, such as an image or video. If a prompt is insufficient for the media model 148 as selected, the language model 144 can update the prompt to enhance the input, and therefore the generated media from the media model 148. Furthermore, the media model 148 may also generate media based on another type of received media. For example, the media model 148 may be employed to generate a video in response to receiving an image, which may also be generated according to a prompt.

The ML engine 140 may further include a 3D model generator 152. The 3D model generator 152 is another generative ML model selector from a variety of generative ML models capable of converting an image to a 3D model. Specifically, the 3D model generator 152 can receive an image to generate a 3D model of the image. The image can be provided to the 3D model generator 152 from the media model 148 or from the media database 136. In some examples, a mobile device 120 can directly provide the image to the 3D model generator 152. The 3D model generator 152 can further map the 3D model to a rig. In an example, a rig can be the skeletal structure of a 3D character or object, further including joints or points at which bones or structures can rotate and move relative to each other.

The animation tool 116 can also include an animation model 156 employable to animate the 3D model. The animation model 156 can receive the 3D model from the 3D model generator 152 to generate an animated 3D model. In some examples, the animation model 156 can receive the 3D model from the media database 136 or directly from a mobile device 120. The animation model 156 can receive another prompt from the mobile device 120 or the language model 144 describing an action to be performed by the 3D model. In response, the animation model 156 can generate an animation of the received 3D model according to the prompt received. In other examples, the animation can be stored in the media database 136 and applied to the 3D model by the animation model 156.

Each of the media model 148, 3D model generator 152, and animation model 156 can receive the updated prompt from the language model 144. Furthermore, the updated prompt can be further adjusted by a corresponding mobile device 120 before being provided to each respective generative model of the machine learning engine 140. The language model 144 can therefore retain a prompt that can be applied to each of the models when creating a 3D animated model starting with the prompt. Because the prompt can be updated prior to being provided as input to each generative model, the prompt can be iteratively refined throughout the process of generating the 3D animated model. Accordingly, the language model 144 interprets intent, which can be confirmed by a mobile device 120 when initially receiving a prompt. The intent, through the iteratively refined prompt, can be carried out by each model of the machine learning engine 140 because the prompt and its intent is retained. The language model 144 can store the prompt internally, or the language model 144 can store the iteratively refined prompt in the media database 136.

Because the prompt is iteratively refined and stored, a user of a mobile device 120 can “redo” a generated media, 3D model, or animation of the 3D model at various points. For example, if the animation model 156 generates an animated 3D model of a character and a user is unhappy with how the character looks while performing the animation, the user can update the prompt provided to the media model 148 to change the character. The prompt still retains information provided to the animation model 156 and the intent of the prompt, but the prompt can be updated to adjust the media generated by the media model 148. The resultant media generated by the media model 148 in response to the updated prompt can be provided back to the 3D model generator 152 and animation model 156 to create an updated animated 3D model 156. Accordingly, each of the models within ML engine 140 work together to generate animated 3D models. Specifically, the media model 148, 3D model generator 152, and animation model 156 are linked together by the language model 144 that guides the process of generation by iteratively refining prompts.

The ML engine 140 includes additional models that can assist with the adjusting generated media or 3D models. The ML engine 140 can include a replacement model 160 to assist with these adjustments that may not require regeneration of an entire media or 3D model. The replacement model 160 may also be selected from a variety of ML models. In an example, the replacement model 160 can be employed to improve resolution of a media or 3D model. The replacement model 160 can employ mask and mesh operations to improve resolution of the media or 3D model. Furthermore, the replacement model 160 provides functionality to replace specific features of a generated media, such as an image, rather than re-generating the entire image based on a prompt. This functionality can be referred to as “in-painting” and is useful to replace specific features such as a character's hair, color, or pose in the generated media. By eliminating the need to re-generate the media, the replacement model 160 reduces computational complexity and burden of the overall ML engine 140.

The ML engine 140 further includes a screenplay model 164 for generating screenplays of 3D models, as well as animated 3D models, according to a received prompt. The screenplay model 164 can also receive a scene characterization (e.g., text, PDF), such that the prompt informs the screenplay model 164 to animate the 3D model within the scene. The screenplay model 164 can further be prompted to reframe shots and change coverages, as well as suggest shots and coverages via the language model 144. Thus, the screenplay model 164 can generate an animated 3D model within a scene according to specific shots and coverages. Accordingly, the ML engine 140 and the animation tool 116 can be employed to rapidly prototype an animated 3D model and test the animated 3D model in a virtual environment or screenplay. The existing process to generate a an animated 3D model and corresponding screenplay or environment takes weeks, if not months. The animation tool 116, by employing the models of the ML engine 140, can generate an animated 3D in a virtual environment or screenplay using only text input in less than an hour, saving labor and resources associated with generation. Further, the ML engine 140 is able to perform these tasks without reliance on third parties by employing the language model 144 to iteratively update prompts that are retained for each of the models within the ML engine 140.

Additionally, an animated 3D model, scene, and environment can be generated and conveyed between mobile devices 120. In an example, a first user can be on set for a film. The first user can employ a first mobile device 120 (1) to generate a virtual mobile environment characterizing the set using the environment engine 132. A second user can be at a studio with a second mobile device 120 (2), which the second user employs to generate a 3D animated model. Specifically, the second user 120 (2) can employ the ML engine 140 to generate a 3D animated model by only providing as little as one prompt to the language model 144. A third user, who can be a director, can be at an office using a third mobile device 120 (3). The third user can receive the 3D animated model generated by the second mobile device 120 (2) and the virtual environment characterizing the film set by the first mobile device 120 (1). Thus, the director can employ the screenplay model 164 to generate a scene of the 3D animated model within the virtual environment (e.g., the film set). Therefore, a scene of a film can be prototyped using three separate mobile devices 120 in distinct locations using a set of generative models linked together by a language model 144. Furthermore, the third user using the third mobile device 120 (3) can adjust the environment or the animated 3D model based on the resultant screenplay because the ML engine 140 retains the iteratively updated prompts provided to the language model 144.

Furthermore, the ML engine 140 includes a text-to-speech model 170 for converting text to audio of the speech. For example, the text can be extracted from a screenplay stored in the media database 136 or directly entered into a GUI for speech generation. A user can also select a voice for the speech, such as a character's voice. In some examples, the screenplay including the speech can also have an associated character and voice. The ML engine 140 also includes a lip synch model 174 for synchronizing audio of speech with a 3D model's lips and face. The lip synch model 174 may receive audio of speech, which can be from the text-to-speech model 170, as well as a 3D model. In response, the lip synch model 170 may map the audio of the speech to the 3D model to generate a 3D model synchronized with the audio of speech. Similarly, the lip synch model 174 may synch audio of speech with an animated 3D model. Again, these operations can be performed using the ML engine 140 using multiple mobile devices 120.

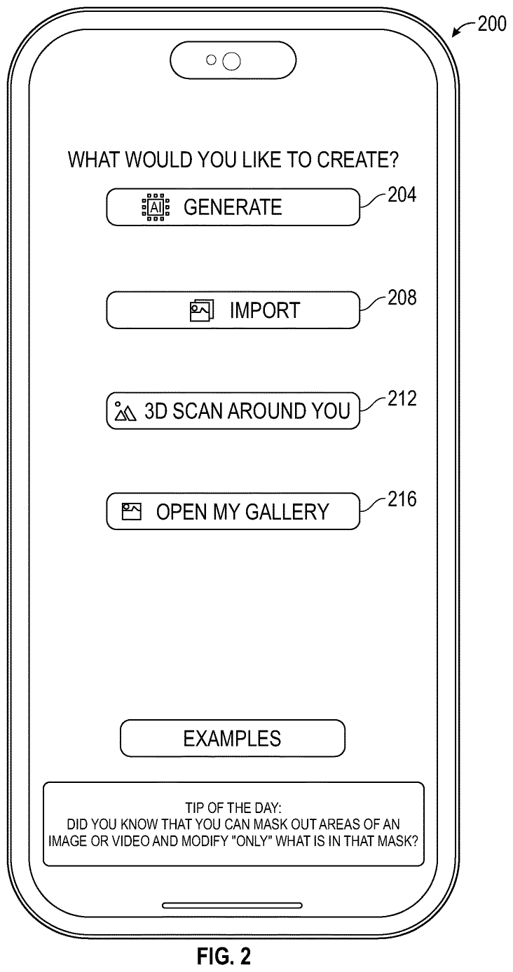

FIGS. 2-23 illustrate GUIs generated by the GUI framework 124 of FIG. 1. The GUIs as illustrated in FIGS. 2-23 are rendered by a mobile device 120 of FIG. 1 and can transmit data with animation tool 116 of FIG. 1, such that reference can be made to FIG. 1 in the examples of FIGS. 2-23. Each of the GUIs in FIGS. 2-23 can have selectable elements, text fields, or image data that receive input from a user, which can be processed and/or provided to the animation tool 116. In response to user interaction with a selectable element for example, a user can provide input to the respective mobile device 120, which is configured to provide or receive data from the animation tool 112 via a network 128. Similarly, the GUIs can include text elements where a user can input text, such as a prompt.

FIG. 2 illustrates an example start GUI 200 generated by the GUI framework 124 of FIG. 1 and rendered on a given mobile device 120. As illustrated, the start GUI 200 can be representative of a “home page” or a GUI provided in response to a request for implementing the animation tool 116. The start GUI 200 includes selectable elements that correspond to various actions of the animation tool 116. For example, a start generation element 204 can be selected to generate a media such as an image or video, as well as a 3D model or animated 3D model. The start GUI 200 also includes an import element 208 for importing one of said image, video, 3D model, or animated 3D model. Using the import element 208, screenplays or virtual environments can also be imported. Start GUI 200 further includes a 3D scan element 212 to begin a 3D scan of a physical environment with the respective mobile device 120 to generate a representative virtual environment, image, or 3D model. Start GUI 200 also includes a gallery element 216 for viewing a gallery of photos, videos, screenplays, which may be saved locally to the memory of the mobile device 120.

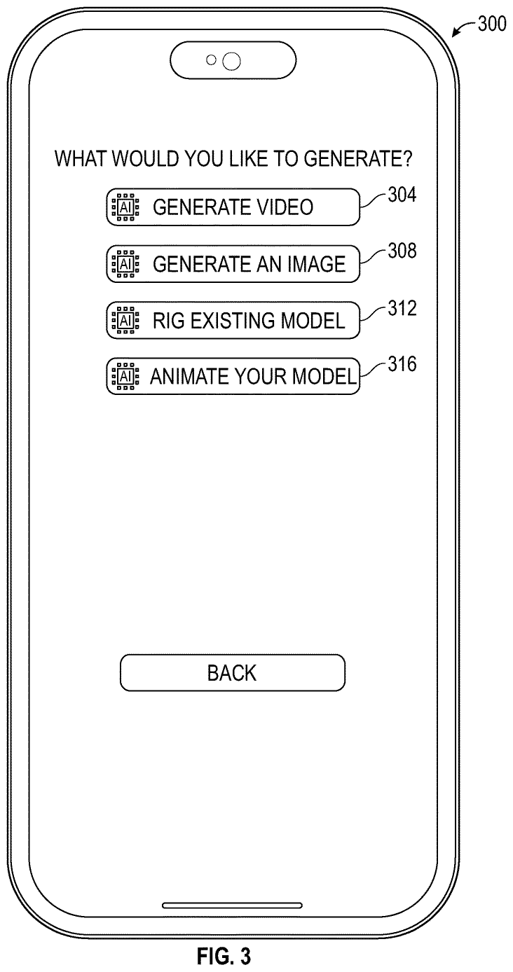

FIG. 3 illustrates a media generation GUI 300, which may be generated by the GUI framework 124 and rendered by the mobile device 120 in response to selection of the start generation element 204. The media generation GUI 300 includes additional selectable elements, including a generate video element 304 and a generate image element 308. In response to selection of the generate video element 304 or the generate image element 308, the animation tool 116 may deploy the image model 148 to generate a video or image. Additionally, the media generation GUI 300 may further generate rig element 312. In response to selection of generate rig element 312, the animation tool 116 may deploy the 3D animated model generator 152 to rig a 3D model. Media generation GUI 300 may also include a generate animation element 316. In response to selection of the generate animation element 316, the animation tool 116 may deploy the animation model 156 to animate a 3D model.

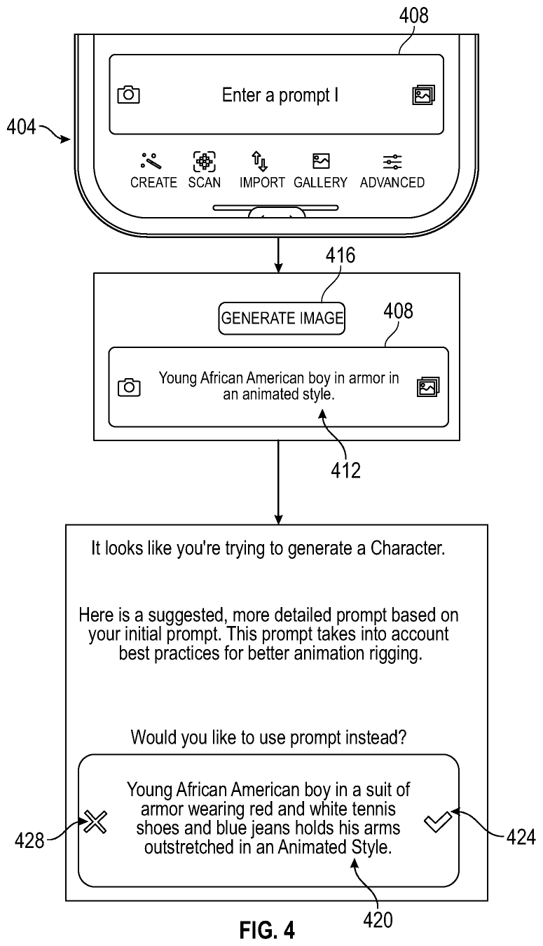

FIG. 4 illustrates a flowchart diagram of GUIs for generating an image, which may be implemented in response to selection of generate image element 308 of the media generation GUI 300. An initial prompt GUI 404 includes an initial prompt element 408 for receiving text (e.g., a prompt) from a user of the mobile device 120 that is provided to the language model 144. An initial prompt 412 is input to the initial prompt element 408. Accordingly, a generate image element 416 is provided in response to initial prompt 412 being received by the initial prompt element 408. If the generate image element 416 is selected, the animation tool 116 generates an image using the initial prompt 412.

Conversely, the language model 144 of the animation tool 116 can provide an updated initial prompt 420. As depicted in FIG. 4, the language model 144 provides more detail to the initial prompt 412 based on best practices for generating an animated 3D model to generate the updated initial prompt 420. Further, the language 144 identifies the intent of the initial prompt 412, such as the intent to generate a “character,” instead of, for example, an object or scene. The updated initial prompt 420 can be accepted via an acceptance element 424 or rejected via a rejection element 428. In response to selection of the rejection element 428, the image model 148 can generate the image based on the initial prompt 412. In response to selection of the acceptance element 424, the image model 144 generates the image according to the updated initial prompt 420.

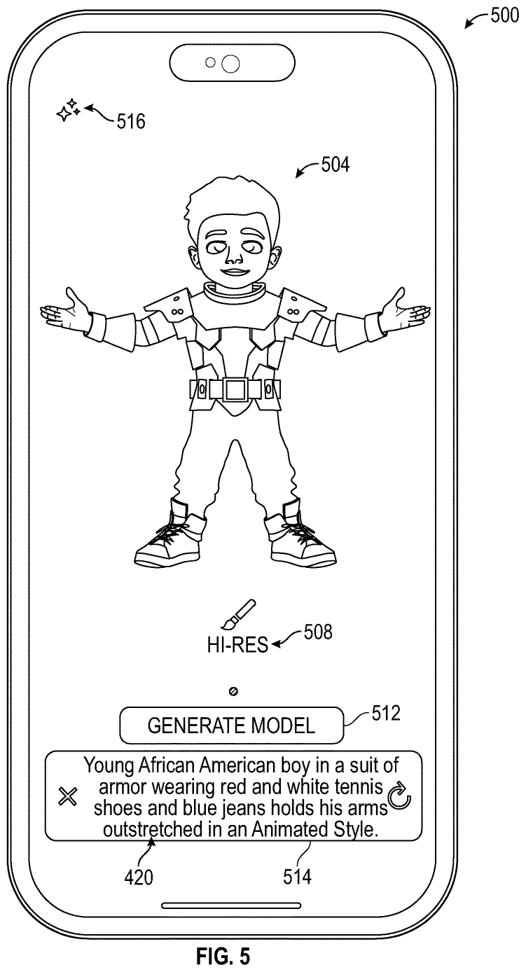

FIG. 5 illustrates an image GUI 500 including an example image 504 generated in response to selection of the acceptance element 424 according to the updated initial prompt 420. The image GUI 500 can have a high-res element 508, which can be employed to perform masking and mesh operation to improve the resolution of the image 504 and subsequent models. The image GUI 500 also includes a generate model element 512, which can be selected to generate a 3D model of the image 504. Here, the updated initial prompt 420 can be applied via an image prompt field 514 to generate the 3D model of the image. In other examples, a new prompt can be provided to the image prompt field 514 to generate the 3D model of the image.

The image GUI 500 also includes a model selection element 516. The model selection element 516 can be used to further alter, adjust, or select a type of media model 148 used to generate the example image 504. That is, the media model 148 can be selected from a variety of different types of generative ML models employable by the ML engine 140. In some examples, the type of media model 148 can be selected based on the context of the prompt (e.g., updated initial prompt 420), which can be directed to a realistic image, cartoon image, etc. Moreover, the model selection element 516 can be employed to further alter, adjust, or select a type of 3D model generator 152 used to generate a 3D model. Again, the type of 3D model generator 152 can be selected from a variety of different ML models based on the needs of the 3D model, such as resolution, realism, etc. In some examples, the type of ML models implemented to generate images, 3D models, or animations is selected by the language model 144 based on intent derived from received prompts.

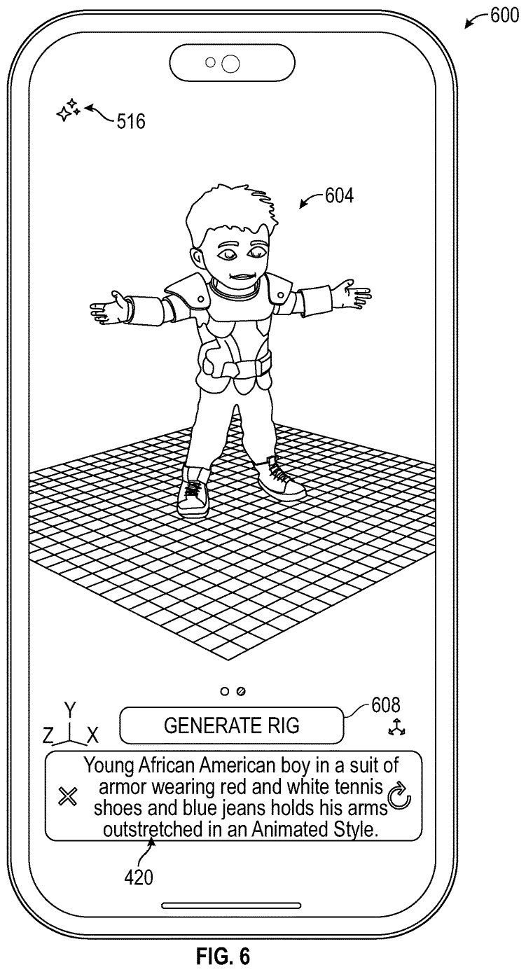

FIG. 6 illustrates 3D GUI 600, which includes the 3D model 604 of the image 504 in a 3D space 606. The 3D model 604 can be generated by a 3D model generator 152 of the ML engine 140 of FIG. 1. A user can interact with the 3D GUI 600 to rotate, translate, and inspect the 3D model 604. The 3D GUI 600 also includes a generate rig element 608, which can be employed to generate an animation of the 3D model 604. Further, the updated initial prompt 420 is retained to generate the 3D model 604 and generate the animation.

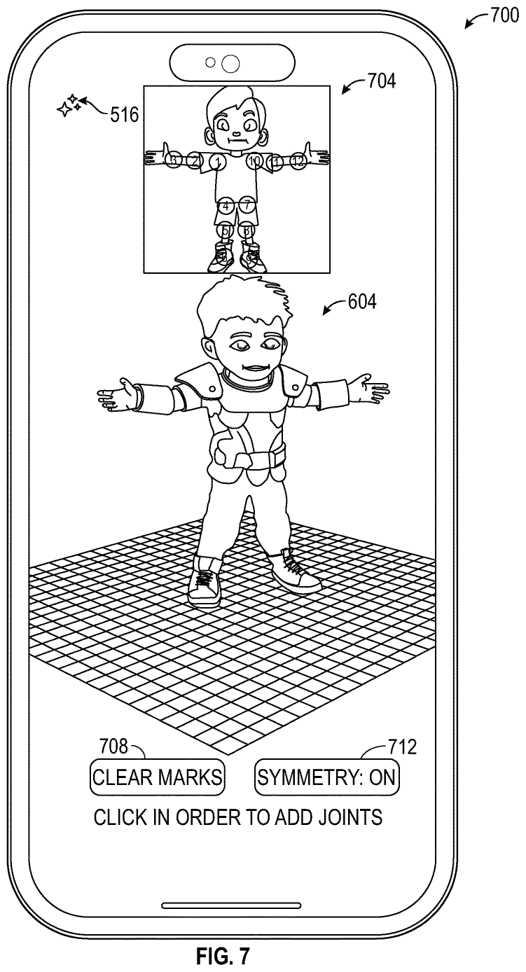

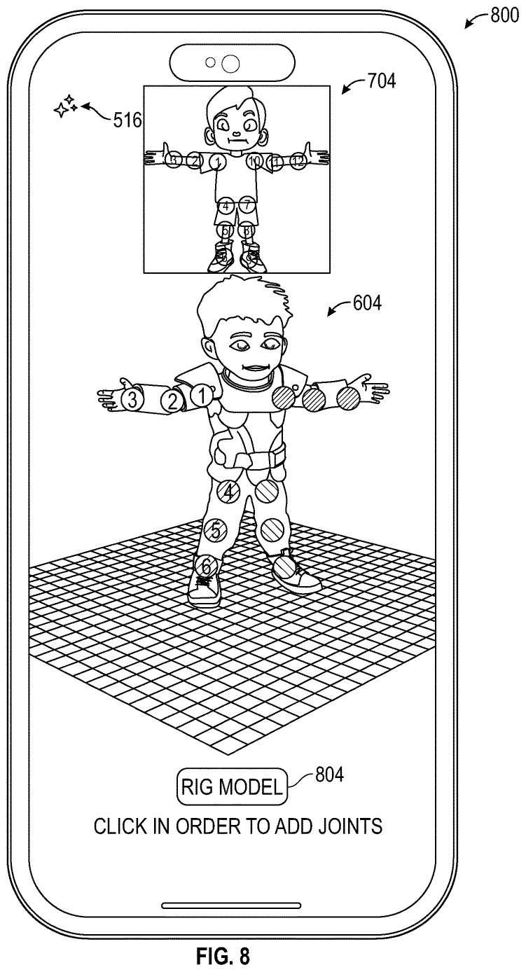

FIG. 7 illustrates a rig GUI 700, which includes the 3D model 604 in the 3D space 606. Here, the rig GUI 700 can be employed to associate joints of the 3D model 604 with a structure 704 representative of the structural (e.g., skeletal) model of the 3D model 604. Accordingly, the structure 704 informs an animation model (e.g., the animation model 156 of FIG. 1) how various sub-structures (1)-(12) (e.g., arms, legs, joints) move relative to each for purposes of animation. The user can select specific sub-structures (1)-(12) to map them to the specific portions of the 3D model 604. The rig GUI 700 includes a clear element 708 to delete all previously identified associations between sub-structures and the 3D model 604. The rig GUI 700 also includes a symmetry element 712, which maps corresponding sub-structures (1)-(12) symmetrically across the 3D model 604. For example, sub-structures (1) and (10) are the left and right shoulders, respectively. FIG. 8 illustrates a mapped rig GUI 800, which illustrates the 3D model 604 having sub-structures (1)-(12) mapped to the 3D model 604 using the symmetry element 712. Specifically, the 3D model 604 of the mapped rig GUI 800 includes sub-structures (1)-(6) of the structure 704 mapped to the left side of the 3D model 604, with the right side of the 3D model having marks symmetrically mapped to the left side. Once the structure 704 is rigged and verified by the user, the user may select the rig model element 804 to generate a rigged 3D model.

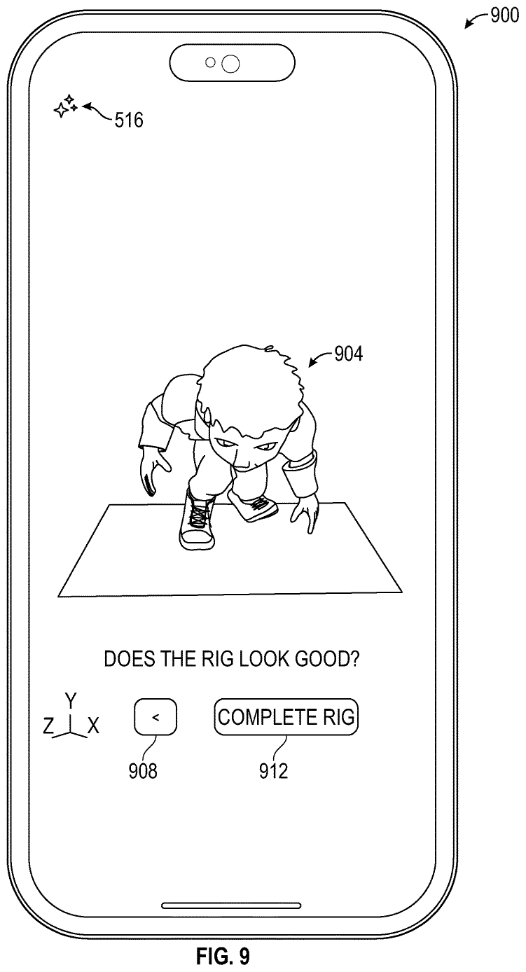

FIG. 9 illustrates a rigged 3D model GUI 900. The rigged 3D model GUI 900 illustrates a rigged 3D model 904, which is the 3D model 604 being mapped to the structure 704 of the rig GUI 700. Accordingly, the rigged 3D model GUI 900 illustrates the rigged 3D model 904 in multiple positions for a user of the mobile device 120 to inspect and verify that the 3D model 604 is accurately mapped to the structure 704. If the rigged 3D model 904 is unacceptable, the rigged 3D model GUI 900 includes a back element 908 to return to the rig GUI 700 to map the structure 704 to the 3D model 604 again. Conversely, the rigged 3D model GUI 900 also includes a complete rig element 912, which can be selected if the rigged 3D model 904 is acceptable.

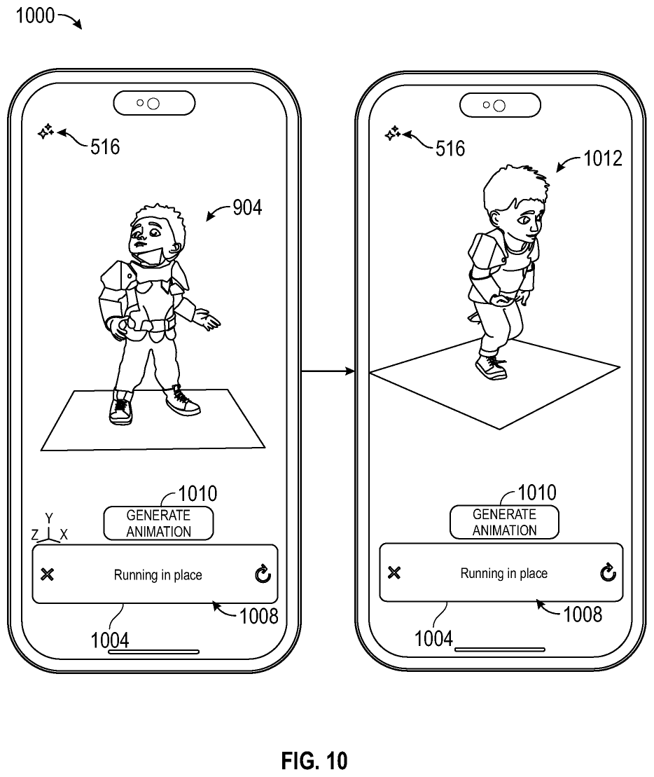

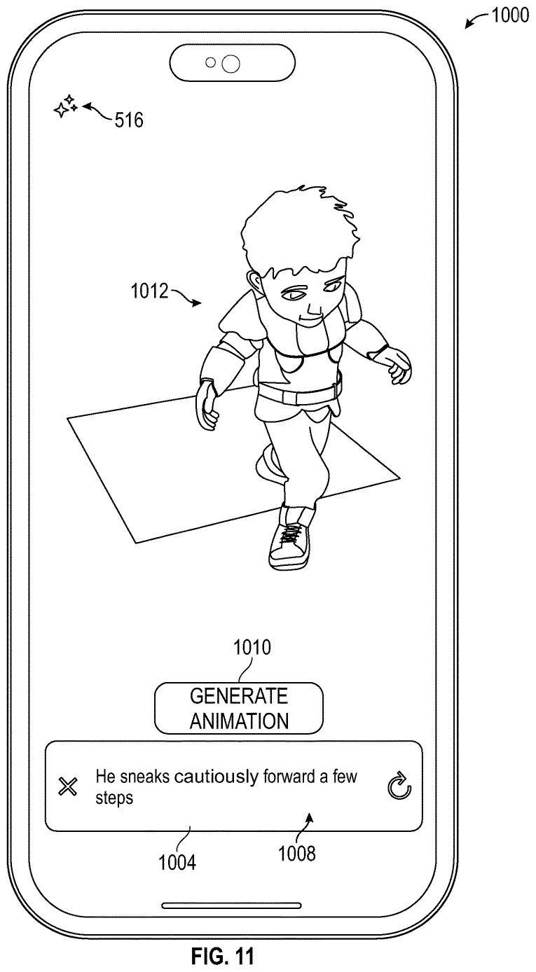

FIG. 10 illustrates an example animation generation page 1000. The animation generation page 1000 illustrates the rigged 3D model 904, as well as an animation text input field 1004. The animation text input field 1004 can receive an animation prompt 1008 that is employed to animate the rigged 3D model 904 in response to selection of a generate animation element 1010. The animation prompt 1008 can be provided to the language model 144, which can relate the animation prompt to the initial prompt 412 used to generate the image 504 for the rigged 3D model 904. Thus, the language model 144 can retain specific information, such as the updated initial prompt 420 to inform the generation of the animation. For example, the animation prompt 1008 is “running in place,” which could be impacted by an initial prompt for generating an image of a character with a walking cane or brace. The language model 144 can therefore provide the animation prompt 1008, or an updated animation prompt, to the animation model 156 to generate an animated 3D model 1012. In other examples, the animation model 156 can directly receive the animation prompt 1008 to generate the animated 3D model 1012. In either example, the animated 3D model 1012 is the rigged 3D model 904 performing the action provided in the animation prompt 1008. FIG. 11 illustrates another example animation page 1100, which illustrates an animated 3D model 1012 generated in response to another example animation prompt 1008.

Referring back to FIG. 3, selection of the generate rig element 312, the animation tool 116 may deploy the 3D animated model generator 152 to generate a rigged 3D model 904 using a previously generated 3D model stored in the media database 136. Thus, the 3D GUI 600, which includes the 3D model 604 of the image 504 in a 3D space 606, can be deployed in response to selection of the generate rig element 312. Similarly, selection of the generate animation element 316 deploys the animation model 156 to generate an animated 3D model 1012 using a previously rigged 3D model 904. The previously rigged 3D model 904 can be received or selected from the media database 136. In other examples, a previously generated rigged 3D model 904, 3D model 604, or image 504 can be provided by one of the mobile devices 120.

The animation tool 116 can further perform various features to improve quality of animated 3D models, such as increasing resolution. To increase resolution, the animation tool 116 includes a replacement model 160 configured to perform masking and mesh operations. These operations can be performed on an image (e.g., the image 504 of FIG. 5), a 3D model (e.g., the 3D model 604 of FIG. 6), a rigged 3D model (e.g., the rigged 3D model 904 of FIG. 9), and an animated 3D model (e.g., the animated 3D model 1012 of FIG. 10). Returning to FIG. 5, these operations can be implemented in response to selecting the high-res element 508.

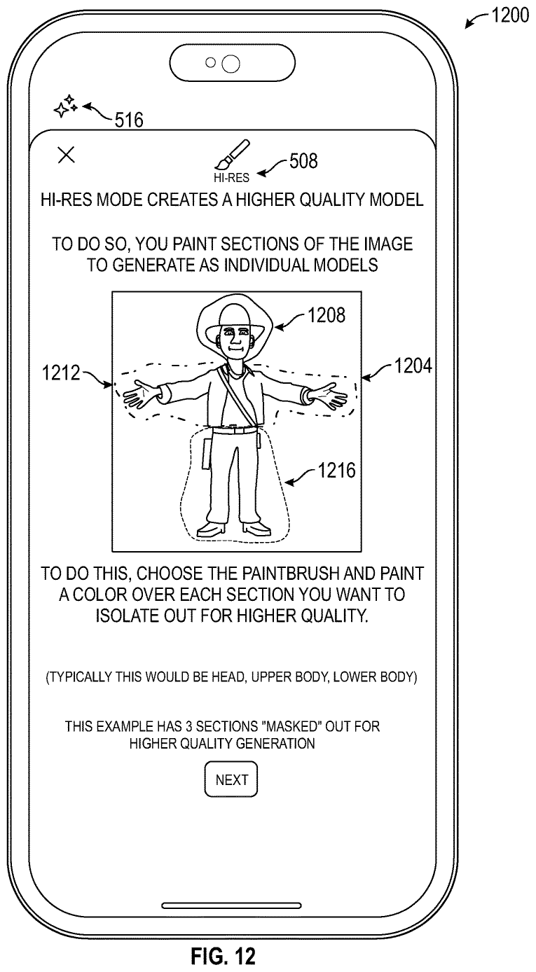

FIG. 12 illustrates an example masking GUI 1200 for masking operations implemented by the replacement model 160. The masking GUI 1200 includes another example image 1204 of a character. A user of the mobile device 120 can employ the masking GUI 1200 to select individual portions of the image 1204. For example, a head 1208, a torso 1212, and legs 1216 are selected using the masking GUI 1200. These different portions are re-generated at the machine learning engine 140, which can create higher resolution images by generating portions of the image 1204 individually.

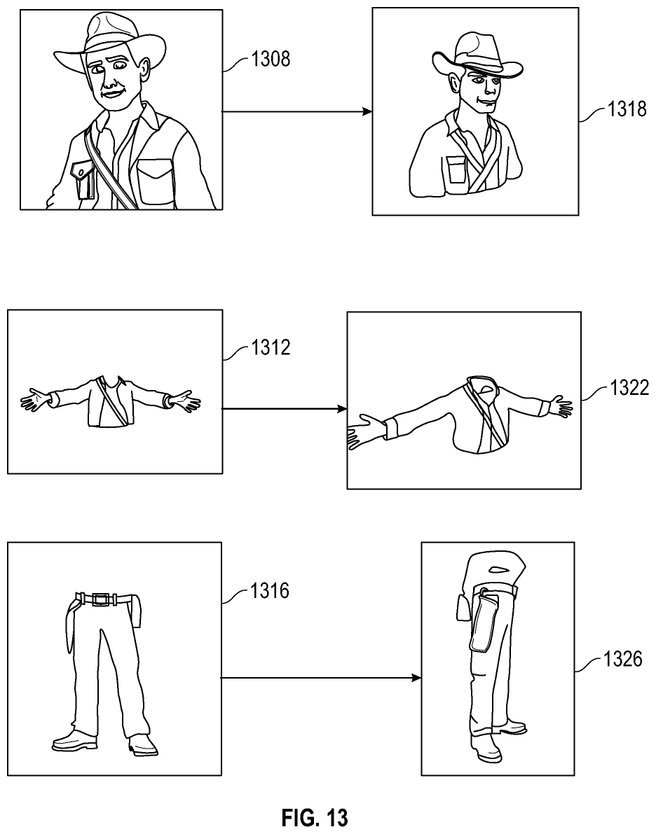

FIG. 13 illustrates an example of model generation of individual portions of an image 1204 using the replacement model 160. Specifically, FIG. 13 illustrates an updated head image 1308, an updated torso image 1312, and an updated legs image 1316. Each of these images can be generated using the respective masks of FIG. 12 and approval by the user of the mobile device 120. In response, the user can select a generate rig element (not illustrated in FIG. 13) to generate respective models of these updated images. The respective models include a head model 1318, a torso model 1322, and a legs model 1326.

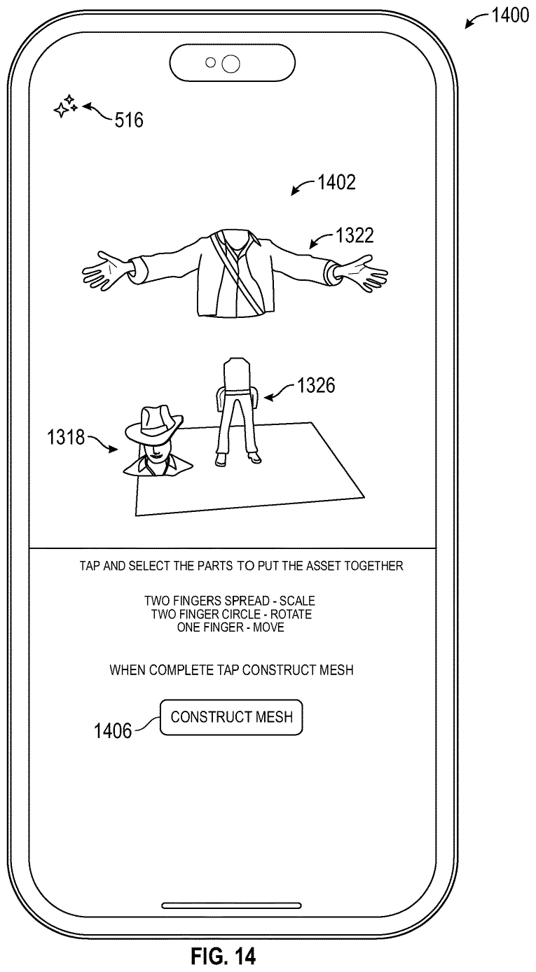

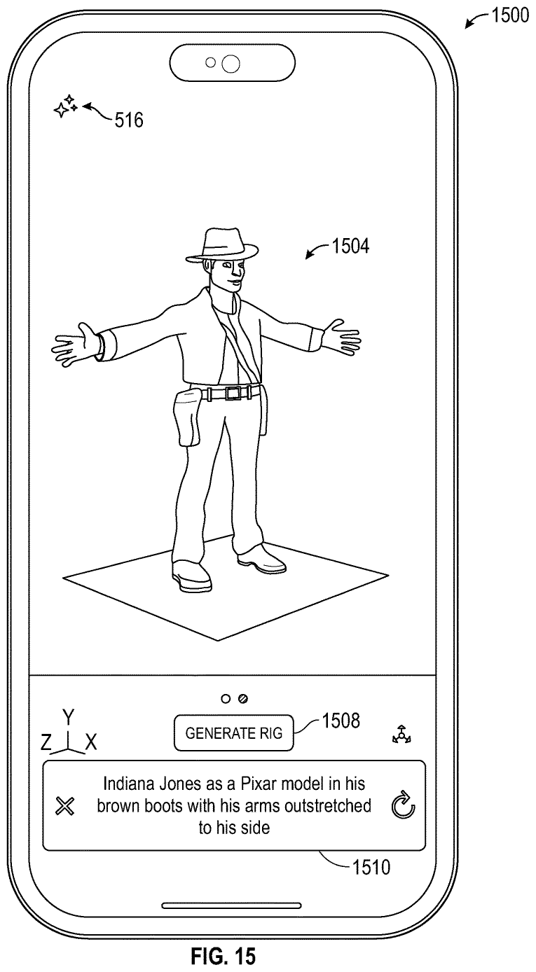

FIG. 14 illustrates an example mesh GUI 1400 for mesh operations implemented by the replacement model 160. The mesh operations include a 3D mesh space 1402 for assembling the head model 1318, torso model 1322, and the legs model 1326. Each of the models can be scaled, rotated, and moved within the mesh GUI 1400. Once placed, the mesh GUI 1400 includes a selectable construction element 1406 for generating a 3D model using the constructed mesh of the head model 1318, torso model 1322, and legs model 1326. FIG. 15 illustrates another example 3D GUI 1500 to provide another example 3D model 1504. Here, the example 3D GUI 1500 includes the 3D model 1504 constructed from the head model 1318, torso model 1322, and legs model 1326 via mesh operations with the mesh GUI 1400 and replacement model 160. The 3D GUI 1500 also includes a generate rig element 1508, such that the 3D GUI 1500 can correspond to the 3D GUI 600 of FIG. 6. Similarly, the 3D GUI 1500 may include a text field for a rig prompt 1510, which may be employed to generate the rig, or finalize the 3D model 1504. Moreover, the rig prompt 1510 may be suggested based on the previous mask and mesh operations, as well as previously input prompts.

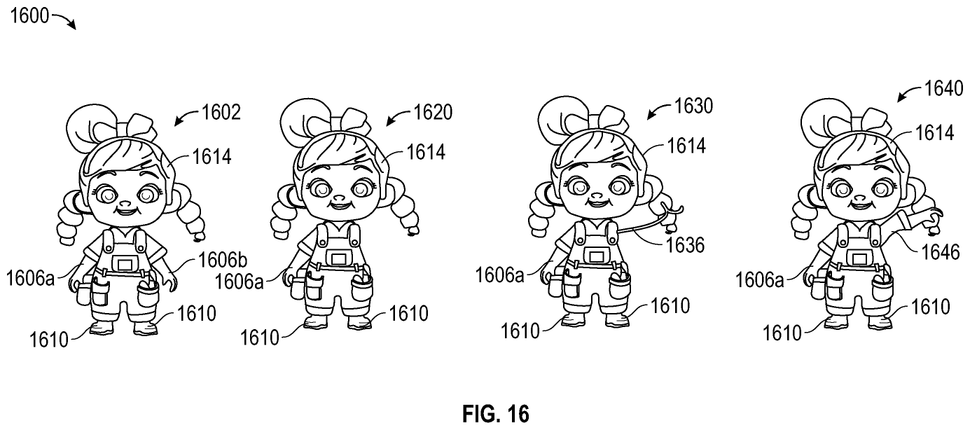

In another example, the replacement model 160 can employ “painting” methods or operations to allow a user of the mobile device to edit images or 3D models. FIG. 16 illustrates an example of pose adjustment GUIs 1600 operable to adjust a pose of a character within an image 1602. Specifically, the example image 1602 can be generated by the media model 148 and rendered by, for example, an image GUI 500. The generated example image 1602 is of a character with arms 1606, legs 1610, and a head 1614. Similar to the masking operations of the replacement model 160, the replacement model 160 can implement paint operations to adjust parts of the image 1602, rather than re-generating the entire image 1602. For example, a blocked image 1620 is the character of the generated image 1602 having the same legs 1610 and head 1614, as well as a first arm 1606a. However, the second arm 1606b of the blocked image 1620 has been “blocked” or removed from the character via editing. In a re-drawn image 1630, the character retains the legs 1610, head 1614, and the first arm 1606b, similar to the blocked image 1620. However, the re-drawn image 1630 includes a re-drawn arm 1636 in place of the second arm 1606b. The re-drawn arm 1636 can be placed by a user using the pose adjustment GUI 1600 to represent a desired pose of the second arm 1606b. In response, the user can accept the re-drawn arm 1636 to generate a re-generated image 1640, where the character has a re-generated arm 1646 in place of the second arm 1606b. The re-generated arm 1646 resembles the second arm 1606b in a pose corresponding to the re-drawn arm 1636.

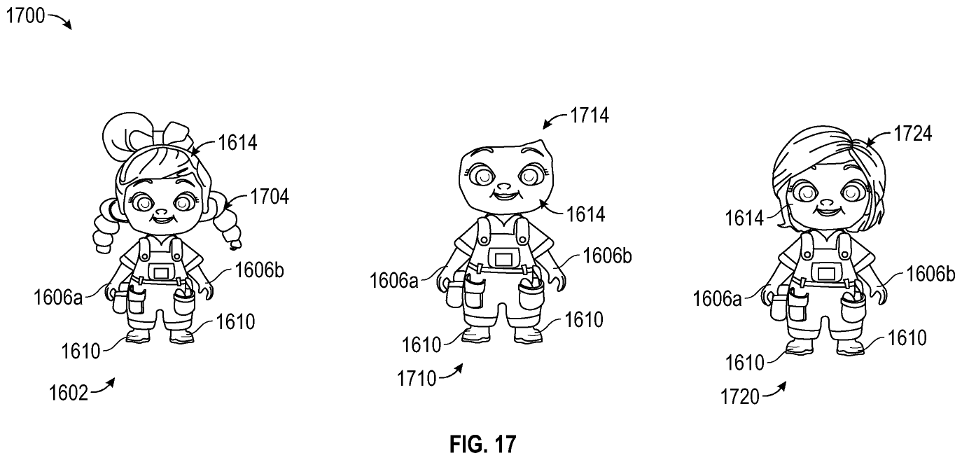

In another example, FIG. 17 illustrates an example of replacement GUIs 1700 operable to replace specific parts of an image or 3D model. Again, the example image 1602 can be generated by the media model 148 and rendered by, for example, an image GUI 500. The generated example image 1602 is of the character with arms 1606, legs 1610, and head 1614, the head 1614 including hair 1704. Again, the replacement model 160 can employ paint operations to adjust parts of the image 1602, rather than re-generating the entire image 1602. For example, the painted image 1710 includes paint 1714 covering what would be the hair 1704 as illustrated in the example image 1602. The replacement model 160 can detect that the hair is to be replaced based on the painted image 1710 and generate the replacement image 1720. Replacement model 160 can further receive input, such as a prompt, indicating a color, size, or style of hair to replace the hair 1704 of the original example image 1602 to generate the replacement image 1720 with replacement hair 1724. As explained with respect to mask, mesh, and paint operations, the replacement model 160 can be employed by a mobile device to edit only parts of an image or 3D model. Therefore, the replacement model 160 obviates the need to re-generate an entire image, which is computationally expensive and required by existing systems.

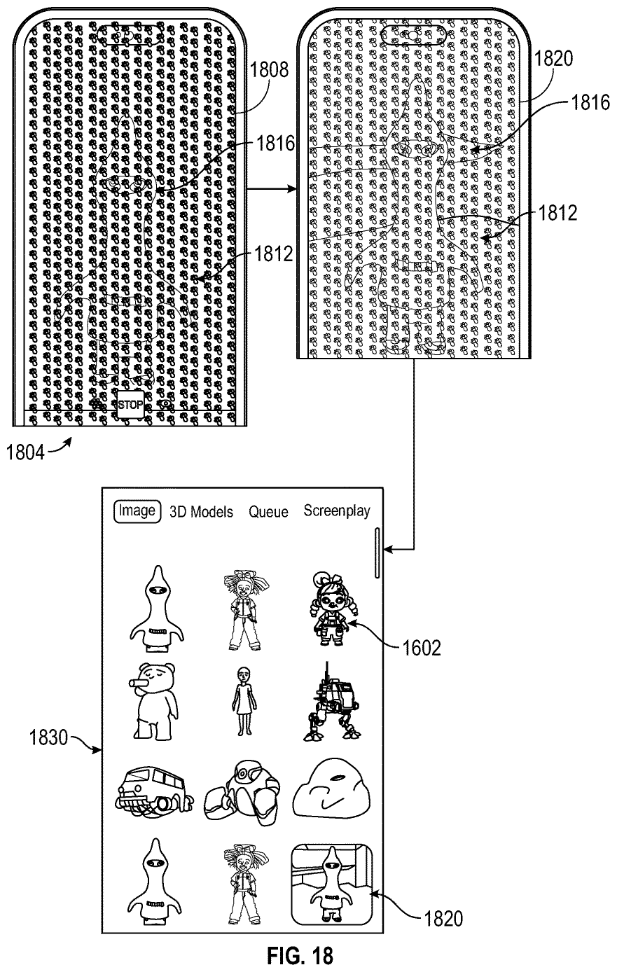

Returning to the start GUI 200 of FIG. 2, the 3D scan element 212 can be selected to begin a 3D scan. FIG. 18 illustrates a scanning GUI 1804, which can be displayed in response to selection of the 3D scan element 212 of FIG. 2. The scanning GUI 1804 renders a point cloud over an image 1808 of an example physical environment 1812 received by a camera of the mobile device 120. Accordingly, the point cloud is used by, for example, the environment engine 132 to detect depth and, therefore, a character 1816 within the image 1808. Therefore, the environment engine 132 can use the point cloud to differentiate the character 1816 from a background (e.g., physical environment 1812) of the image 1808 to generate a scanned image 1820. Furthermore, the environment engine 132 can receive one or multiple scans (e.g., images 1808 with point clouds) of the physical environment to generate a 3D model of the character 1816 within the image 1808. The environment engine 132 can save the scanned image 1820 having the character 1816, with or without the background, to the media database 136. Thus, an image selection GUI 1830 can be employed, for example, in response to the import element 208 of FIG. 2, to select the scanned image 1820 from other images saved in the media database 136. Accordingly, the scanned image 1820 can be employed to generate a 3D model similar to other saved images, such as example images 504 and 1602 of FIGS. 5 and 16.

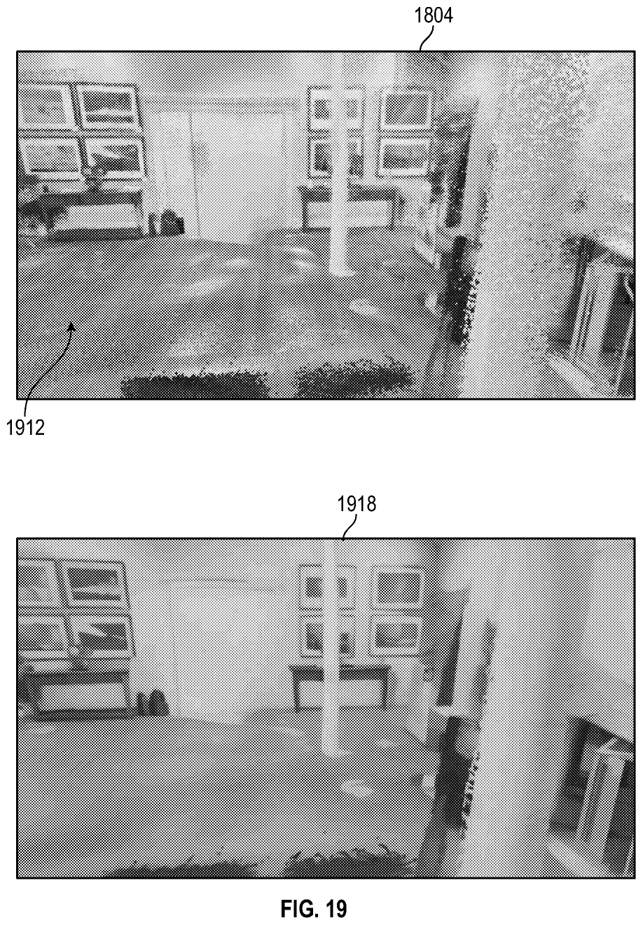

FIG. 19 illustrates another example of the scanning GUI 1804. Here, the scanning GUI 1804 scans another example physical environment 1912, which does not include a specific character or object for extraction or to distinguish against a background of the physical environment 1912. Instead, the scanning GUI 1804 scans the physical environment 1912 using a point cloud to generate a virtual environment 1918. The point cloud is used to extract depth of various objects within the physical environment 1912 to generate a representative virtual environment 1918. Thus, the virtual environment 1918 can include objects within the physical environment 1912. However, the entire physical environment 1912 and its constituent objects and components are included in the virtual environment 1918, which is a 3D representation of the physical environment 1912. As illustrated, the virtual environment 1918 includes textures and planes instead of a cloud of points as illustrated in the scanning GUI 1804. Further, the virtual environment 1918 can be modified according to a style, such as a cartoon or realism, by the environment engine 132 and/or with the help of the ML engine 140.

The environment engine 132 may be further employed to render 3D models and animated 3D models in a virtual reality (VR), an augmented reality (AR), or a semi-AR environment. In a VR environment, media such as images, 3D models, and animated 3D models may be placed within a virtual environment (e.g., the virtual environment 1918 of FIG. 19). The VR environment may be generated, by the environment engine 132 in conjunction with the ML engine 140 and a prompt, to represent an environment that does not exist in the physical world. The environment engine 132 can be used to place media within the VR environment. An AR environment overlays digital information (e.g., media), such as images, sounds, or other data—onto the real world (e.g., the physical environment 1912), enhancing the user's perception and interaction with their surroundings. Unlike VR, which creates an immersive digital environment, AR integrates and supplements the real world with virtual elements, allowing users to see and interact with both simultaneously. Accordingly, an AR environment can be the virtual environment 1918 that is used to represent the physical environment 1912, but is altered according to media or prompts. A semi-AR environment refers to an environment where AR elements are used in a partial manner, rather than fully integrating digital content with the real world. That is, a semi-AR environment can be generated by specifying objects or locations within the virtual environment 1918 to adjust or alter, which can be specified through a prompt. Therefore, the environment engine 132 and ML engine 140 can be employed to generate a variety of environments, which can be generally referred to as a virtual environment 1918 herein.

Similar to images, 3D models, and animated 3D models, the virtual environment 1918 can be stored in the media database 132. Moreover, generated 3D models and animated 3D models can be placed within the virtual environment for viewing. The 3D models can be scaled, rotated, and otherwise edited in the virtual environment 1918 to prototype the 3D model and associated animations. Further, the virtual environment 1918 can be created for specific location, such as a film set, and transmitted to another mobile device 120 positioned at a location other than the film set. Therefore, a first mobile device 120 (1) can be used to generate the 3D model (e.g., the 3D model 604 of FIG. 6 or the 3D model 1504 of FIG. 15), a second mobile device 120 (2) can be used to generate the virtual environment 1918, and a third mobile device 120 (3) can be used to render and inspect the 3D model within the virtual environment generated by different mobile devices.

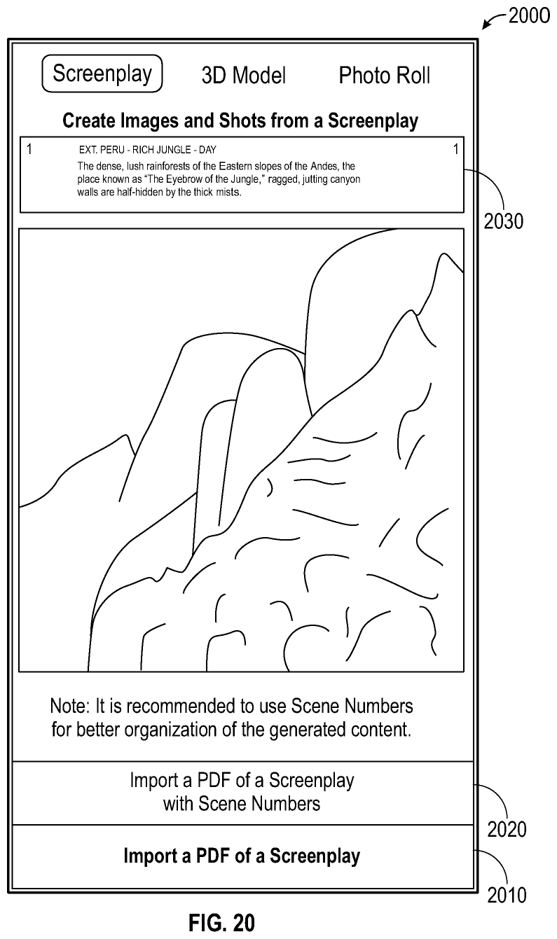

FIG. 20 illustrates an example screenplay import GUI 2000. A scene can generated using one or more of a screenplay, a prompt (e.g., updated initial prompt 420 of FIG. 2), a saved image (e.g., image 504 of FIG. 5), a 3D model (e.g., the 3D model 604 of FIG. 6 or the 3D model 1504 of FIG. 15), an animated 3D model (e.g., the animated 3D model 1012 of FIG. 10), and a virtual environment (e.g., the virtual environment 1918 of FIG. 19). A screenplay can include one or more scenes, which may further include scene numbers. Accordingly, the screenplay GUI 2000 can include a screenplay element 2010 for importing a screenplay. The screenplay import GUI 2000 may also include a numbered screenplay element 2020 for importing a screenplay that has scene numbers. A given screenplay may include further information, such as a cast and a style. Each scene may have its own cast and style, and each scene may include further information such as a shot and coverage. Further, the screenplay import GUI 2000 may be used to extract scene information 2030. The scene information 2030 may be used as an initial screen prompt to generate an image or shot directly from the imported screenplay. For example, the initial screenplay image 2040 can be generated directly from the screenplay import GUI 2000. Accordingly, the initial screenplay image 2040 and scene information 2030 may be retained and employed by the ML engine 140 to inform and update subsequent prompts and generation of media.

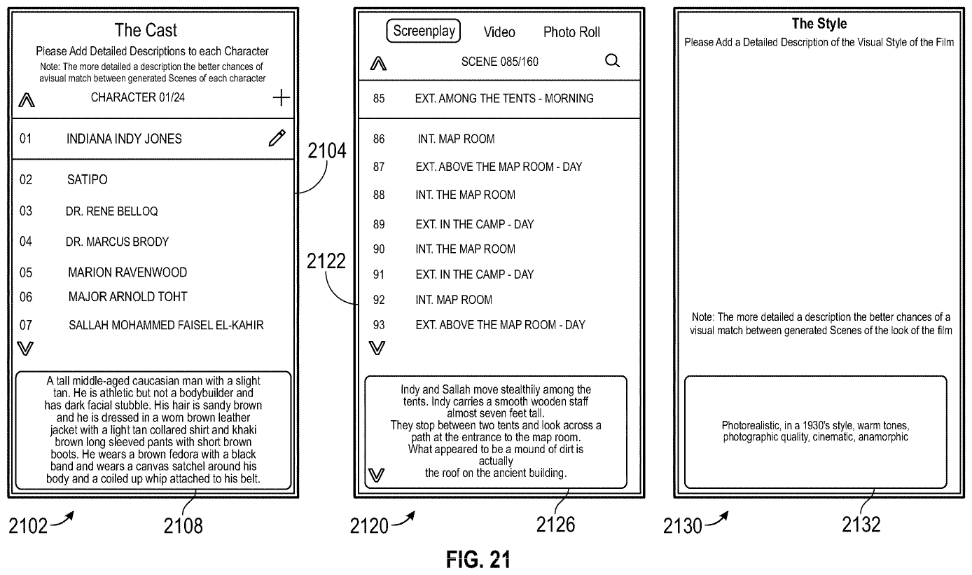

FIG. 21 is an example of screenplay generation GUIs. Specifically, FIG. 21 illustrates a cast selection GUI 2102. Within the screenplay imported via the screenplay import GUI 2000 can be a list of characters 2104, which is rendered by the cast selection GUI 2102. The list of characters 2104 can be a list of selectable character elements. In response to selecting a character element from the list of characters 2104, a user can import media (e.g., an image, 3D model, animated 3D model) to associate with the selected character. Alternatively, a user can provide a cast prompt 2108, which can be received by the language model 144 and employed by the ML engine 140 to generate an image or 3D model of the character. That is, a user can generate the media of the character selected according to the provided cast prompt 2108, which can be an image, video, 3D model, or animated 3D model according to the methods described herein.

The screenplay generation GUIs can also include a scene generation GUI 2120. The scene generation GUI 2120 can include scene list 2122, which can be provided by the screenplay. Here, the user can select a selectable scene from the scene list 2122 and provide a scene prompt 2126 to describe the scene. Additionally, the screenplay GUIs can include a style GUI 2130, which includes a text field for receiving a style prompt 2132. Accordingly, the scene prompt 2126, style prompt 2132, selected scene, and associated characters can be provided to the screenplay model 164 to generate a scene.

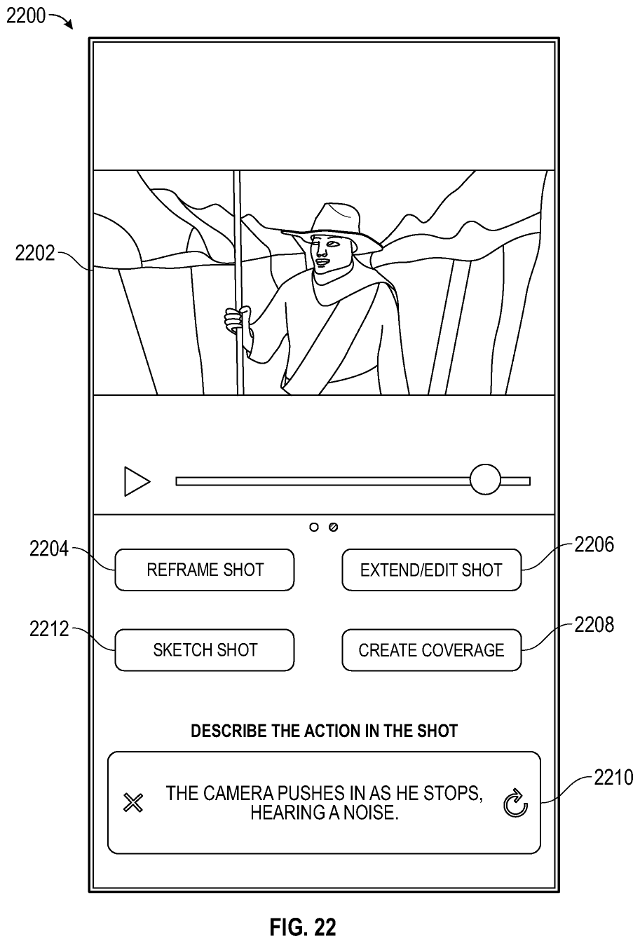

FIG. 22 illustrates an example scene editing GUI 2200. The scene editing GUI 2200 includes a video scene 2202 generated using the screenplay generation GUIs. In some examples, the screenplay generation GUIs can be employed to generate an image via the image model 144 that is employed to generate the video scene 2202. Here, the scene editing GUI 2200 includes selectable elements for editing the video scene 2202. For example, a reframe element 2204 can be selected to reframe the video scene 2202. The scene editing GUI 2200 can also include an extension element 2206 employable to extend or adjust a time of the video scene 2202. The scene editing GUI 2200 can also include a coverage selection element 2208 to implement different coverages, which may be selected from a list of predefined shots such as a wide shot, medium close-up, reverse shot, and cowboy shot.

The scene editing GUI 2200 can further include an edit shot prompt 2210. The edit shot prompt 2210 allows a user to describe a desired shot, such as a camera angle, movement, or position relative to a character or object in the video scene 2202. The edit shot prompt 2210 may be used to perform other functions such as framing, or to further refine the scene prompt 2126. Again, these prompts may be provided to the language model 144 that can retain previous prompts, infer intent, and provide suggestions. The scene editing GUI 2200 further includes a sketch shot element 2212 that is selectable to implement sketch operations, which may be performed by the replacement model 160.

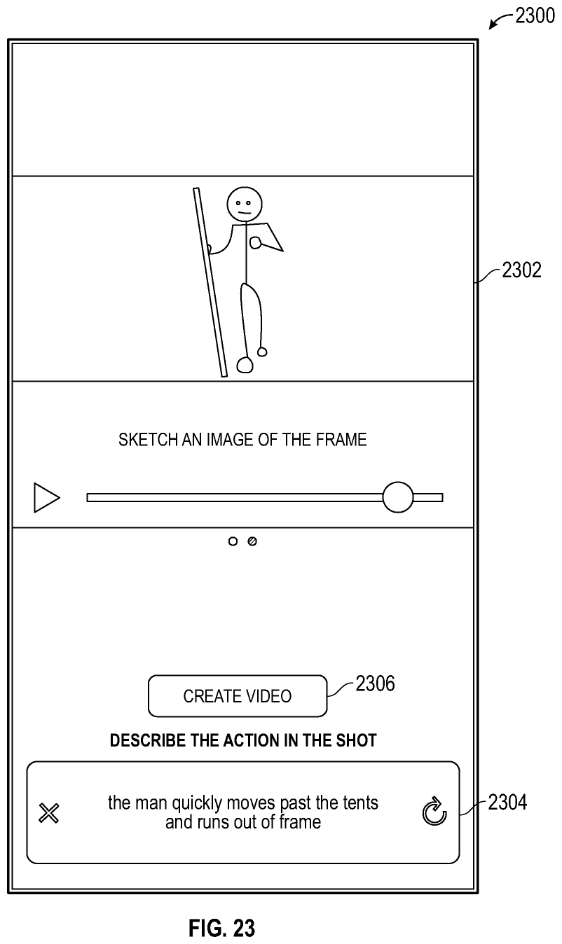

FIG. 23 illustrates an example sketch GUI 2300. The sketch GUI 2300 includes a paint area 2302, which can be employed to implement paint operations of the replacement model 160. Here, a desired frame can be drawn into the paint area 2302. As illustrated, a “stick figure” having a desired pose is drawn into the paint area 2302. The sketch GUI 2300 also includes a sketch prompt 2304, which can describe the desired frame, as well as the desired scene. Accordingly, the replacement model 160 in conjunction with the ML engine 140 can generate a video of the scene using the sketch prompt 2304, paint area 2302, and previously received prompts and generations for the screenplay. The video can be generated in response to selection of create video element 2306, which can render a video of the video scene 2202 updated according to the sketch prompt 2304 and paint area 2302.

The web-based animation system 100 offers a comprehensive and efficient solution for generating 3D animated models and virtual environments compared to existing systems. The animation tool 116 within the system allows clients to request and generate 3D animated models using text input, which can be iteratively refined through a graphical user interface (GUI) framework 124. In addition to text input provided as prompts, which are retained throughout the animation generation process, the animation tool 116 provides various operations to mobile devices to accurately indicate desired images, 3D models, and animations to the animation tool 116. The animation tool 116 supports rapid prototyping of 3D models and animations, enabling users to view and edit these models in various virtual environments across multiple mobile devices 120.

The animation tool integrates different machine learning (ML) models within the ML engine 140 that retains information such as prompts, and previously generated media. The ML engine 140 includes a language model 144, media model 148, 3D model generator 152, and animation model 156, which work together to iteratively refine prompts and generate high-quality 3D animated models. The system also features a replacement model 160 for improving resolution and making specific adjustments without regenerating entire models, thus reducing computational complexity. Additionally, the screenplay model 164 allows for the rapid generation of screenplays and scenes, significantly shortening the time required to create animated content from weeks or months to less than an hour. This efficiency is conferred to the animation tool 116 as a result of the integration between the ML models to iteratively receive, refine, and retain prompts and generated media. This efficiency and the functionality of the animation tool is extended with the ability to share and edit models across different locations and devices.

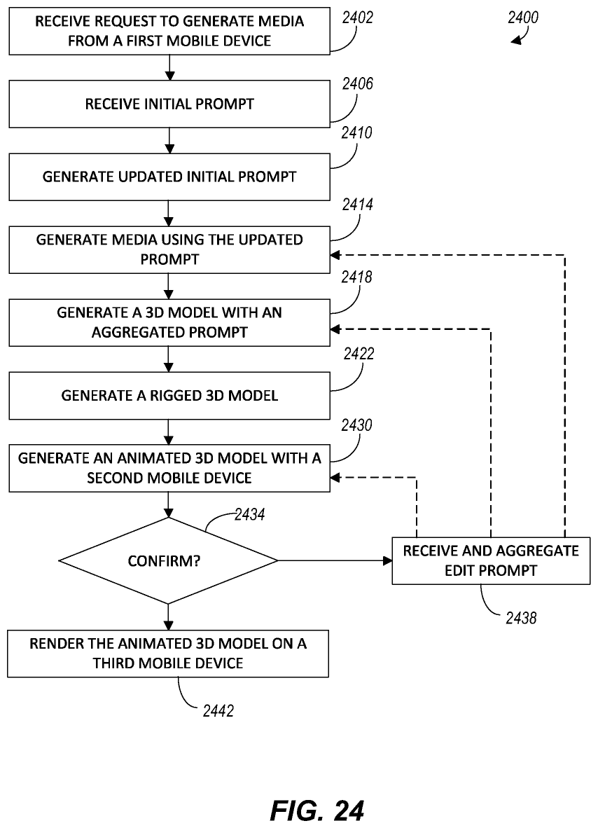

In view of the structural and functional features described above, example methods will be better appreciated with reference to FIGS. 1-23. While, for purposes of simplicity of explanation, the example methods of FIGS. 24-28 are shown and described as executing serially, it is to be understood and appreciated that the present examples are not limited by the illustrated order, as some actions could, in other examples, occur in different orders, multiple times, and/or concurrently from that shown and described herein. Moreover, it is not necessary that all described actions be performed to implement the methods, and conversely, some actions may be performed that are omitted from the description.

FIG. 24 is an example of a method 2400 for generating and transmitting an animation. The method 2400 can be implemented by the animation tool 116, as shown in FIG. 1, as well as GUIs generated by the GUI framework 124 and employed by the mobile devices 120. Thus, reference can be made to the examples of FIGS. 1-23 in the example of FIG. 24. The method 2400 can begin at 2402 by receiving a request to generate media from a first mobile device 120 (1) (e.g., the first mobile device 120 (1) of FIG. 1). The request to generate media can be, for example, in response to selection of a generate image element (e.g., the generate image element 308 of FIG. 3) of a media generation GUI (e.g., the media generation GUI 300 of FIG. 3). In some examples, the request to generate media can be in response to selection of a generate video element (e.g., the generate video element 304 of FIG. 3). Accordingly, at 2402, the animation tool can provide an initial prompt GUI (e.g., the initial prompt GUI 404 of FIG. 4) to the first mobile device in response to the request to generate media.

At 2406, the animation tool receives an initial prompt, which is provided to a machine learning (ML) engine (e.g., the ML engine 140 of FIG. 1). Specifically, the initial prompt is provided to a language model (e.g., the language model 144 of FIG. 1), which analyzes the initial prompt using advanced natural language processing. At 2410, in response to receiving the initial prompt, the language model provides an updated initial prompt (e.g., the updated initial prompt 420 of FIG. 4) to the first mobile device. Specifically, at 2410, the language model performs advanced language processing such as semantic analysis, to extract context and infer intent from the initial prompt. For example, an initial prompt may generally describe a character with style (e.g., animated) wearing a type of clothes (e.g., western). The language model may infer, for example, context missing from the initial prompt based on the prompt provided to improve detail and clarity, such as a cowboy hat, boots, and pants. Moreover, the language model may also be informed that the initial prompt is for a specific type of media and therefore model within the ML engine. Accordingly, the language model may improve detail to increase performance of the anticipated model and expected output (e.g., an image), such that the language model provides a pose or texture to increase suitably of the anticipated model. Thus, at 1210, the language model provides the updated initial prompt and retains the initial prompt and updated initial prompt, for example, in a media database (e.g., the media database 136 of FIG. 1).

At 2414, the updated initial prompt is received by a media model (e.g., the media model(s) 148 of FIG. 1) to generate the requested media with the updated initial prompt, which can occur in response to selection of a selectable element (e.g., the generate image element 416 of FIG. 4) on the first mobile device. At 2418, the language model can receive an image prompt (e.g., image prompt 514 of FIG. 5) from the first mobile device via an image GUI (e.g., the image GUI 500 of FIG. 5) and generate a 3D model (e.g., the 3D model 604 of FIG. 6). The image prompt can include language (e.g., features, context) omitted from the updated initial prompt. Yet, the language model retains the updated initial prompt, such that the language model can aggregate the image prompt, updated initial prompt, and image generated at 2414 to generate the 3D model. Specifically, the aggregated image and updated initial prompt, as well as the image, are provided to a 3D model generator (e.g., the 3D model generator 152 of FIG. 1) to generate the 3D model. Therefore, the 3D model can be generated according to the original intent inferred from the updated initial prompt, but slightly modified or altered based on the image prompt. Specifically, the image prompt may add context to include or update a texture or style of the 3D model. However, the image prompt does not need to restate the language included in the updated initial prompt because the updated initial prompt is retained by the language model or the ML engine.

At 2422, a rigged 3D model (e.g., the rigged 3D model 904 of FIG. 9) is generated using a rig GUI (e.g., the rig GUI 700 of FIG. 7). Specifically, a user can employ the rig GUI to map a structure (e.g., a skeletal structure, the structure 704 of FIG. 7) to the 3D model. The rigged 3D model therefore provides structure such as joints, which can provide additional context to an ML model for generating an animation of the 3D model. At 2426, a second mobile device (e.g., second mobile device 120 (2) of FIG. 1) can generate an animated 3D model (e.g., the animated 3D model 1012). Specifically, the rigged 3D model can be provided to the second mobile device via a network (e.g., the network 128 of FIG. 1) by the first mobile device or the animation tool. To generate the animated 3D model, the second mobile device can provide an animation prompt (e.g., animation prompt 1008) to an animation model 156, which also receives the rigged 3D model. The animation prompt can also be aggregated with the updated initial prompt and image prompt and provided to the animation model 156. Therefore, the animation model 156 can generate the animated 3D model with context and intent inferred from prompts provided by the first mobile device, which are retained by the ML engine 140.

At 2434, a user of the second mobile device can confirm whether the animated 3D model is acceptable. If the animated 3D model is unacceptable (e.g., “NO”), the second mobile device can be employed to generate an edit prompt for regenerating one of the media, 3D model, rigged 3D model, or animated 3D model. For example, the animated 3D model may be missing a desired piece of clothing or a desired feature. Accordingly, the edit prompt may be aggregated with the previous prompts (e.g., the animation prompt, updated initial prompt, image prompt) at 2438 and provided back to the media model at 2414 to regenerate the image. In another example, the animated 3D model may have failed to render a portion of the 3D model during animation, such as the underside of a wing not visible in the 3D model. Accordingly, the edit prompt may be aggregated with previous prompts at 2438 and provided back to the 3D model generator at 2418 to regenerate the 3D model. In yet another example, the user of the second mobile device may wish to edit the animation to change how the 3D model moves. Accordingly, the edit prompt may be aggregated with previous prompts at 2438 and provided back to the animation model at 2430 to regenerate the animated 3D model. These alternatives are illustrated by a dashed line.

If the animated 3D model is acceptable at 2434, the animated 3D model can be rendered in a virtual environment (e.g., the virtual environment 1918 of FIG. 19) on a third mobile device at 2442. Specifically, the third mobile device can generate or receive the virtual environment. In an example, the virtual environment can be a virtual representation of a physical environment (e.g., the physical environment 1912 of FIG. 19), which can be a film set. Accordingly, the animated 3D model can be created and transmitted across distributed devices (e.g., the mobile devices) while retaining prompts and associated information (e.g., intent, context). The first, second, and third mobile devices can be in different locations, such that a prototype of a film scene at the film set can be generated without requiring each of mobile devices to be on location. Moreover, the virtual environment can be stored in the media database, or provided by fourth mobile devices, such that none of the mobile devices are required to be at the film set to generate a scene of the 3D animated model within the virtual environment. Moreover, the method 2400 can be implemented using only one mobile device rather than three. Further, the edit prompt can be received and aggregated with previous prompts after any of the steps 2410-2442. Further still, the method 2400 can begin at any of the steps by importing previously generated media.

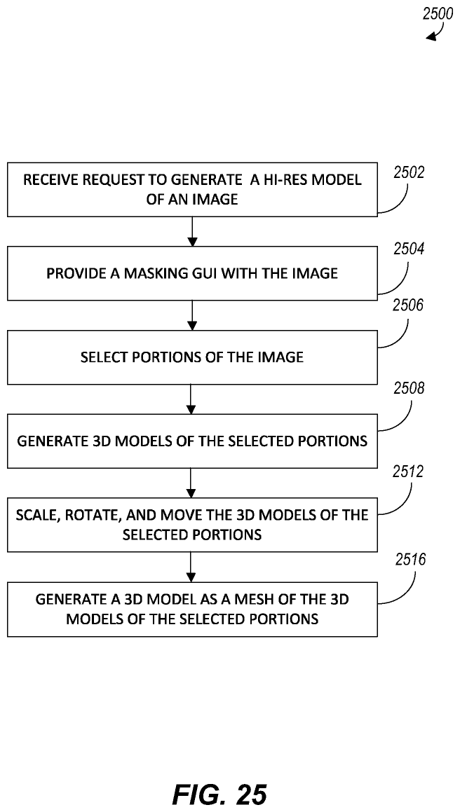

FIG. 25 illustrates an example method 2500 for creating a hi-resolution (“hi-res”) 3D model (e.g., the 3D model 1504). The method 2500 can begin at 2502 by receiving a request from a mobile device (e.g., the mobile device 120) to create a hi-res 3D model. The request can be received in response to selection of a high-res element (e.g., the high-res element 508 of FIG. 5), which can be provided as selectable element with an image GUI (e.g., the image GUI 500 and at step 2418 of method 2400). At 2504, a masking GUI (e.g., the masking GUI 1200 of FIG. 12) for masking operations is provided to the mobile device, the masking operations being performed by a replacement model (e.g., the replacement model 160 of FIG. 1). Specifically, the masking GUI allows a user to select specific portions (e.g., a head 1208, torso 1212, and legs 1216 of FIG. 12) of an image (e.g., the image 1204 of FIG. 12). At 2506, the specific portions of the image are selected via the masking GUI. At 2508, each selected portion of the image is employed to generate a respective 3D model of the selected portions using the 3D model generator (e.g., the 3D model generator 152 of FIG. 1). Because portions of the image are employed to generate 3D models instead of the larger original image, the respective 3D models of the selected portions (e.g., the head model 1318, torso model 1322, and legs model 1326) have a higher resolution compared to a 3D model generated using the larger original image.

At 2512, the 3D models of the selected portions are provided to the mobile device within a mesh GUI (e.g., the mesh GUI 1400) to enable mesh operations, which are performed by the replacement model. Specifically, at 2512, the 3D models of the selected portions are scaled, rotated, and moved within a virtual 3D space (e.g., the 3D mesh space 1402) to construct the 3D model. Each of the 3D models of the selected portions can be precisely scaled and positioned relative to each other using the mesh GUI at 2512. At 2516, the replacement model constructs the 3D model as a mesh of the 3D models of the selected portions. Because the 3D model is a mesh of the individually generated 3D portions of the larger image, the 3D model constructed via mesh operations has a relatively higher resolution than a 3D model constructed from only the image. Accordingly, the method 2500 can be used in place of or conjunction with step 2418 of method 2400.

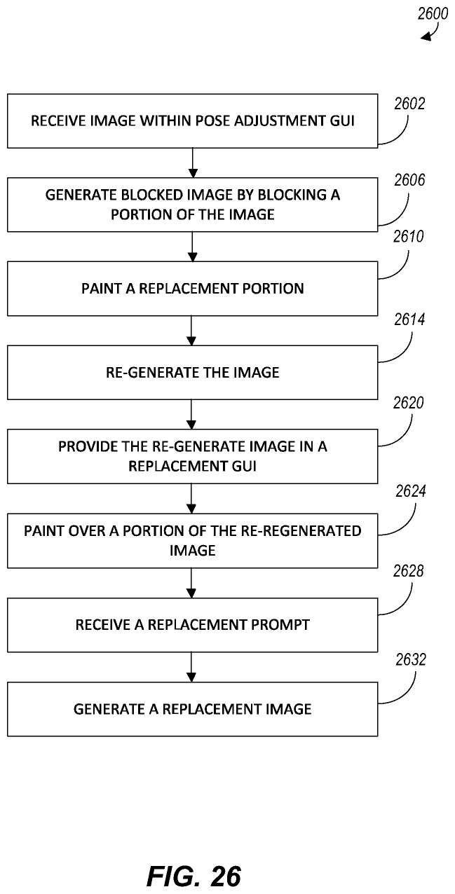

FIG. 26 illustrates a flowchart of an example method 2600 for replacing portions of an image (e.g., the image 1602 of FIG. 16, the image 504 of FIG. 5, the image 1204 of FIG. 12) using paint operations. The method 2600 can begin at 2602 by receiving, via a mobile device, the image within a pose adjustment GUI (e.g., the pose adjustment GUI 1600). The pose adjustment GUI allows a user of the mobile device to block one or more of the portions (e.g., head 1614, arms 1606, and legs 1610 of FIG. 16). Accordingly, a blocked image is generated at 2606, which can be generated by a replacement model (e.g., the replacement model 160 of FIG. 1) by removing the blocked portions from the image. At 2610, the pose adjustment GUI can be employed to paint a replacement portion (e.g., the replacement arm 1636 of FIG. 16) in a preferred pose (e.g., the re-drawn image 1630 of FIG. 16). At 2614, a re-generated image (e.g., re-generated image 1640 of FIG. 16) is generated by the replacement model or the media model (e.g., the media model 148 of FIG. 1), or a combination thereof. Specifically, the re-generated image is generated using the re-drawn image, the re-generated image having the blocked portion of the blocked image in a different pose.

At 2620, the re-generated image can be provided to the mobile device with a replacement GUI (e.g., the replacement GUIs 1700 of FIG. 17). The head of the re-generated image may further include a portion (e.g., hair 1704) that a user of the mobile device wishes to replace. At 2624, a user paints over the portion of the re-generated image using the replacement GUI. At 2628, the replacement GUI may receive a prompt indicating the desired change to the portion of the re-generated image. The prompt may be aggregated with previous prompts retained by the ML engine (e.g., the ML engine 140 of FIG. 1). At 2632, a replacement image (e.g., the replacement image 1720) is generated, having desired hair according to the prompt received at 2628 in place of the portion painted over at 2624. Thus, the replacement image has the blocked portion in a different pose and the painted over portion replaced according to the prompt. Method 2600 can be implemented within or in conjunction with method 2400, for example, between steps 2414 (generating the media) and 2418 (generating the 3D model). Moreover, method 2600 allows for specific portions of an image to be repositioned or replaced without requiring regeneration of the entire source image. Accordingly, method 2600 reduces the computational burden of regenerating images, especially if only a portion of the image is undesirable.

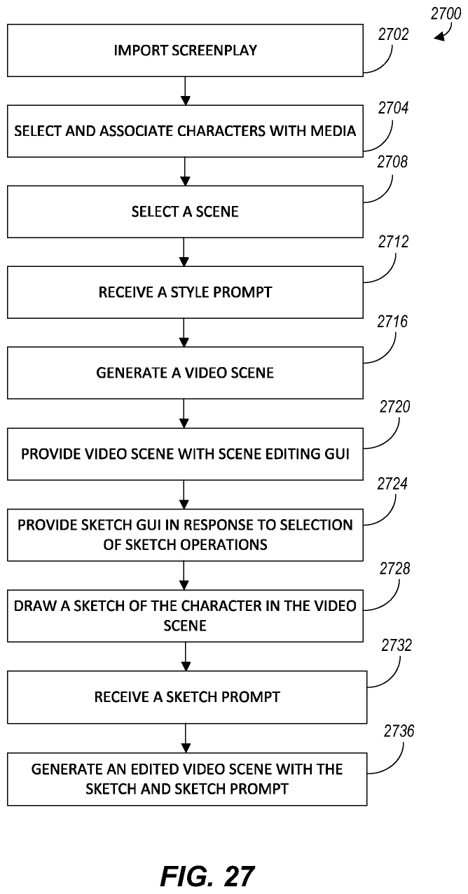

FIG. 27 illustrates an example method 2700 for generating a video scene (e.g., the video scene 2202 of FIG. 22). The method 2700 can begin at 2702 by importing, via a mobile device (e.g., the mobile device 120 of FIG. 1), a screenplay. The screenplay may be saved locally to the mobile device or retrieved from a remote computer (e.g., the computer platform 104). The screenplay can include information such as scene numbers (e.g., the scene list 2122 of FIG. 21) and a cast (e.g., the list of characters 2104 of FIG. 21). At 2704, a user of the mobile device can select a character from the cast and associate the character with an image or 3D model. In some examples, the image or 3D model can be generated at 2704. Alternatively, the image or 3D model can be selected from previously generated images or 3D models (e.g., via the image selection GUI 1830). That is, an image or model generated with methods 2400-2600 can be selected at 2704 to associate with a character from the cast.

At 2708, a scene is selected from the scene list. At 2712, a style prompt (e.g., the style prompt 2132 of FIG. 21) can be received by the mobile device. At 2716, the style prompt, one or more images or 3D models associated with characters of the cast list at 2704, and the selected scene are provided to a screenplay model (e.g., the screenplay model 164 of FIG. 1) that responsively generates the video scene. The video scene is provided at 2720 with a scene editing GUI (e.g., the scene editing GUI 2200), which comprises selectable elements for implementing edits of the video scene. At 2724, a sketch GUI (e.g., the sketch GUI 2300 of FIG. 23) is provided to the mobile device to edit the video scene. At 2728, a sketch can be drawn in a paint area (e.g., the paint area 2302 of FIG. 23). The sketch can be of the character within the video scene in a desired pose. At 2732, a sketch prompt (e.g., the sketch prompt 2304) can be received by the sketch GUI. Accordingly, the sketch prompt and sketch are provided to the screenplay model at 2736, which responsively edits the scene according to the sketch and sketch prompt. Furthermore, the sketch prompt can be aggregated with previous prompts, such as those employed to generate the 3D model or image of the character in methods 2400-2600.

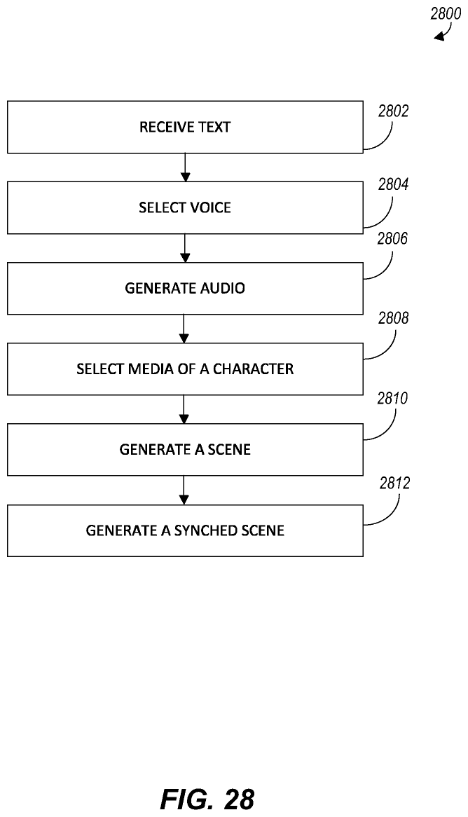

FIG. 28 illustrates a flowchart of an example method 2800 for generating a multi-media scene. The method 2800 can be performed by an ML engine (e.g., the ML engine 140 of FIG. 1). The method 2800 can begin at 2802 by receiving text. The text can be of a script for a character, image, or model to speak or take another action that produces a sound. Accordingly, the text can be received or imported with a screenplay. More specifically, at 2802, the screenplay can be parsed to extract the text. In other examples, the text can be received via a prompt. At 2804, a voice can be selected for the text from a list of voices, such as a list of characters (e.g., the list of characters 2104 of FIG. 21). In other examples, the text may be associated with a character in the screenplay, which also may be extracted at 2804 to identify the character. Additionally, the character or text may also be associated with other sound-producing elements not limited to a voice.

At 2806, audio of the selected voice speaking the text is generated by a text-to-speech model (e.g., the text-to-speech model 170 of FIG. 1). At 2808, a media is selected to synch with the audio generated at 2806. For example, the character in the list may have a pre-generated media stored in a media database (e.g., the media database 136 of FIG. 1) that can be selected to synch with the audio. The audio can be synched with media including images, videos, 3D models, and animated 3D models of the character. In some examples, methods 2400-2600 can be implemented at 2808 to generate desired media. At 2810, a scene is generated by placing the media selected at 2808 in a virtual environment (e.g., the virtual environment 1918 of FIG. 19). The scene can also refer to a video scene (e.g., video scene 2202) generated with method 2700, which includes the media of the character within the scene. At 2812, the character within the scene is synched with the audio generated at 2808 by a lip synch model (e.g., the lip synch model 174 of FIG. 1). That is, multi-media of the character (e.g., media such as a 3D model) within the virtual environment is generated having the character move according to the audio. For example, the audio can be of the character speaking the text received at 2802 and the character can have a mouth (e.g., lips) that are synched to the audio.

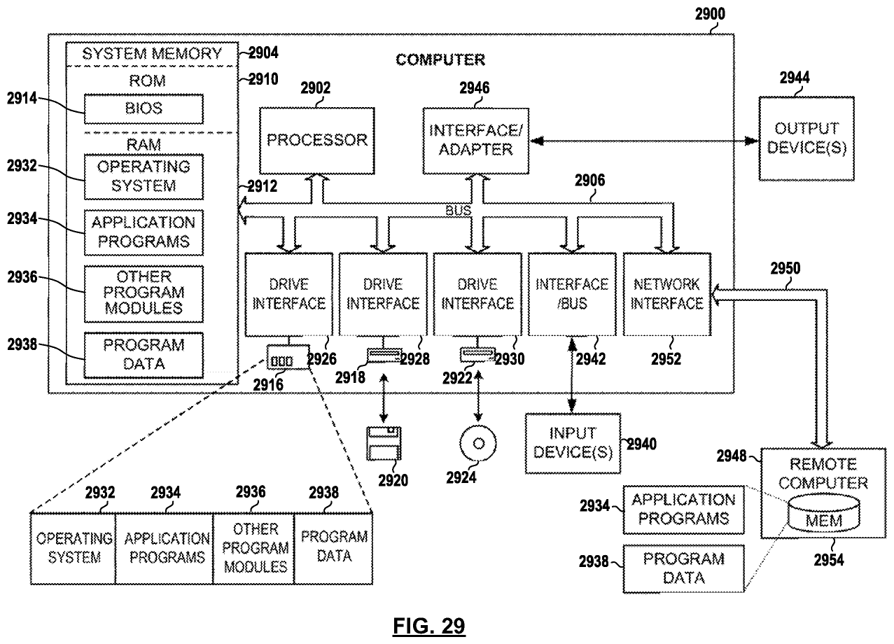

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 29. Furthermore, portions of the embodiments may be a computer program product on a computer-readable storage medium having computer-readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general-purpose computer, special-purpose computer, or other programmable data processing apparatus (or a combination of devices and circuits) to produce a machine, such that the instructions of the machine, when executed by the processor, implement the functions specified in the block or blocks, or in the acts, steps, methods, and processes described herein.

These processor-executable instructions may also be stored in computer-readable memory that can direct a computer or other programmable data processing apparatus to function in a particular manner, such that the instructions stored in the computer-readable memory result in an article of manufacture including instructions that implement the function specified. The computer program instructions may also be loaded onto a computer or other programmable data processing apparatus to cause a series of operational steps to be performed on the computer or other programmable apparatus to realize a computer-implemented process such that the instructions which execute on the computer or other programmable apparatus provide steps for implementing the functions specified in flowchart blocks that may be described herein.

In this regard, FIG. 29 illustrates one example of a computer system 2900 that can be employed to execute one or more embodiments of the present disclosure. Computer system 2900 can be implemented on one or more general-purpose networked computer systems, embedded computer systems, routers, switches, server devices, client devices, various intermediate devices/nodes, or standalone computer systems. Additionally, computer system 2900 can be implemented on various mobile clients, such as, for example, a personal digital assistant (PDA), laptop computer, pager, and the like, provided they include sufficient processing capabilities.

Computer system 2900 includes processing unit 2902, system memory 2904, and system bus 2906 that couples various system components, including the system memory 2904, to processing unit 2902. System memory 2904 can include volatile (e.g., RAM, DRAM, SDRAM, Double Data Rate (DDR) RAM, etc.) and non-volatile (e.g., Flash, NAND, etc.) memory. Dual microprocessors and other multi-processor architectures also can be used as processing unit 2902. System bus 2906 may be any of several types of bus structures, including a memory bus or memory controller, a peripheral bus, and a local bus using any of a variety of bus architectures. System memory 2904 includes read-only memory (ROM) 2910 and random access memory (RAM) 2912. A basic input/output system (BIOS) 2914 can reside in ROM 2910 containing the basic routines that help to transfer information among elements within computer system 2900.

Computer system 2900 can include a hard disk drive 2916, magnetic disk drive 2918, e.g., to read from or write to removable disk 2920, and an optical disk drive 2922, e.g., for reading CD-ROM disk 2924 or to read from or write to other optical media. Hard disk drive 2916, magnetic disk drive 2918, and optical disk drive 2922 are connected to system bus 2906 by a hard disk drive interface 2926, a magnetic disk drive interface 2928, and an optical drive interface 2930, respectively. The drives and associated computer-readable media provide nonvolatile storage of data, data structures, and computer-executable instructions for computer system 2900. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 2912, including operating system 2932, one or more application programs 2934, other program modules 2936, and program data 2938. In some examples, the application programs 2934 can include an animation tool 116, environment engine 132, media database 136, machine learning (ML) engine 140, language model 144, media model(s) 148, three-dimensional (3D) model generator(s) 152, animation model(s) 156, replacement model(s) 160, screenplay model(s) 164, and a graphical user interface (GUI) framework 124. The program data 2938 can include GUI, images, videos, 3D models, rigged 3D models, animated 3D models, virtual environments, and video scenes. The application programs 2934 and program data 2938 can include functions and methods programmed to generate and transmits animations, such as those shown and described herein.

A user may enter commands and information into computer system 2900 through one or more input devices 2940, such as a pointing device (e.g., a mouse, touch screen), keyboard, microphone, joystick, game pad, scanner, and the like. For instance, the user can employ input device 2940 to input, edit, or modify prompts, ML models, mesh operations, mask operations, blocking operations, paint (replacement) operations, and sketch operations. These and other input devices 2940 are often connected to processing unit 2902 through a corresponding port interface 2942 that is coupled to the system bus, but may be connected by other interfaces, such as a parallel port, serial port, or universal serial bus (USB). One or more output devices 2944 (e.g., display, a monitor, printer, projector, or other type of displaying device) is also connected to system bus 2906 via interface 2946, such as a video adapter.

Computer system 2900 may operate in a networked environment using logical connections to one or more remote computers, such as remote computer 2948. Remote computer 2948 may be a workstation, computer system, router, peer device, or other common network node, and typically includes many or all the elements described relative to computer system 2900. The logical connections, schematically indicated at 2950, can include a local area network (LAN) and/or a wide area network (WAN), or a combination of these, and can be in a cloud-type architecture, for example, configured as private clouds, public clouds, hybrid clouds, and multi-clouds. When used in a LAN networking environment, computer system 2900 can be connected to the local network through a network interface or adapter 2952. When used in a WAN networking environment, computer system 2900 can include a modem, or can be connected to a communications server on the LAN. The modem, which may be internal or external, can be connected to system bus 2906 via an appropriate port interface. In a networked environment, application programs 2934 or program data 2938 depicted relative to computer system 2900, or portions thereof, may be stored in a remote memory storage device 2954.

### EXAMPLE CLAUSES

Implementation examples are described in the following numbered clauses:

Clause 1: A method comprising: receiving, by a mobile device, a selection of a media type or a source media; receiving, by the mobile device, a prompt; and receiving, by the mobile device, a three-dimensional animation of the selection based on the prompt in response to providing the prompt and selection to one or more generative artificial intelligence (GAI) models.

Clause 2: The method of clause 1, wherein the selection is of an image.

Clause 3: The method of any one of clauses 1 through 2, wherein the prompt is a first prompt and the method further comprises receiving an image in response to providing the first prompt and selection of an image to a first GAI model of the one or more GAI models.

Clause 4: The method of any one of clauses 1 through 3, further comprising updating the first prompt to an updated first prompt, the updated first prompt being provided to the first GAI model to generate the image.

Clause 5: The method of any one of clauses 1 through 4, further comprising receiving a second prompt, by the mobile device, and receiving a 3D model in response to providing the second prompt and the image to a second GAI model.

Clause 6: The method of any one of clauses 1 through 5, further comprising updating the second prompt to an updated second prompt, the updated second prompt being provided to the second GAI model to generate the 3D model.

Clause 7: The method of any one of clauses 1 through 6, further comprising providing, by the mobile device, the 3D model in a simulated environment.

Clause 8: The method of any one of clauses 1 through 7, wherein the image is a first image, the method further comprising: receiving, by the mobile device, a request to regenerate the image; aggregating the first and second updated prompts into an aggregated prompt; receiving, by the mobile device, a third prompt; and receiving, by the mobile device, a second image in response to providing the aggregated prompt and third prompt to the first GAI model.

Clause 9: The method of any one of clauses 1 through 8, wherein the 3D model is a first 3D model, the method further comprising receiving, by the mobile device, a second 3D model in response to providing the aggregated prompt, third prompt, and the second image to the second GAI model.

Clause 10: The method of any one of clauses 1 through 9, further comprising: receiving, by the mobile device, a third prompt; and receiving, by the mobile device, an animation of the 3D model in response to providing the 3D model and third prompt to a third GAI model.

Clause 11: The method of any one of clauses 1 through 10, further comprising updating the third prompt to an updated third prompt, the updated third prompt being provided to the third GAI model to generate the animation of the 3D model.

Clause 12: The method of any one of clauses 1 through 11, further comprising providing, by the mobile device, the animated 3D model in the simulated environment.

Clause 13: The method of any one of clauses 1 through 12, wherein the mobile device is a first mobile device, the method further comprising providing, by the first mobile device, the animated 3D model and the simulated environment to a second mobile device.

Clause 14: The method of any one of clauses 1 through 13, further comprising user selections of a GAI model for each of the first, second, and third GAI models.

Clause 15: A method comprising: receiving, by a server, a selection from a mobile device; transmitting, by the server, a prompt to the mobile device; and transmitting, by the server, a three-dimensional animation of the selection to the mobile device based on the prompt in response to processing the prompt and selection using one or more generative artificial intelligence (GAI) models.

Clause 16: The method of clause 15, wherein the selection is of an image.

Clause 17: The method of any one of clauses 15 through 16, wherein the prompt is a first prompt and the method further comprises transmitting an image to the mobile device in response to processing the first prompt and selection of an image using a first GAI model of the one or more GAI models.

Clause 18: The method of any one of clauses 15 through 17, further comprising updating the first prompt to an updated first prompt, the updated first prompt being processed by the first GAI model to generate the image.

Clause 19: The method of any one of clauses 15 through 18, further comprising receiving a second prompt from the mobile device, and transmitting a 3D model to the mobile device in response to processing the second prompt and the image using a second GAI model.

Clause 20: The method of any one of clauses 15 through 19, further comprising updating the second prompt to an updated second prompt, the updated second prompt being processed by the second GAI model to generate the 3D model.

Clause 21: The method of any one of clauses 15 through 20, further comprising transmitting the 3D model to the mobile device for display in a simulated environment.

Clause 22: The method of any one of clauses 15 through 21, wherein the image is a first image, the method further comprising: receiving, by the server, a request to regenerate the image from the mobile device; aggregating the first and second updated prompts into an aggregated prompt; receiving, by the server, a third prompt from the mobile device; and transmitting, by the server, a second image to the mobile device in response to processing the aggregated prompt and third prompt using the first GAI model.

Clause 23: The method of any one of clauses 15 through 22, wherein the 3D model is a first 3D model, the method further comprising transmitting, by the server, a second 3D model to the mobile device in response to processing the aggregated prompt, third prompt, and the second image using the second GAI model.

Clause 24: The method of any one of clauses 15 through 23, further comprising: receiving, by the server, a third prompt from the mobile device; transmitting, by the server, an animation of the 3D model to the mobile device in response to processing the 3D model and third prompt using a third GAI model.

Clause 25: The method of any one of clauses 15 through 24, further comprising updating the third prompt to an updated third prompt, the updated third prompt being processed by the third GAI model to generate the animation of the 3D model.

Clause 26: The method of any one of clauses 15 through 25, further comprising transmitting, by the server, the animated 3D model to the mobile device for display in the simulated environment.

Clause 27: The method of any one of clauses 15 through 26, wherein the mobile device is a first mobile device, the method further comprising transmitting, by the server, the animated 3D model and the simulated environment to a second mobile device.

Clause 28: The method of any one of clauses 15 through 27, further comprising receiving user selections of a GAI model for each of the first, second, and third GAI models.

Clause 29: The method of any one of clauses 15 through 28, wherein the first, second, and third prompts are updated using a fourth GAI model.

Clause 30: A system comprising: a server comprising artificial intelligence (AI) models, the AI models comprising; a first AI model for generating a media in response to receiving a first prompt and a selection of a type of media; a second AI model for generating a three-dimensional (3D) model of the media in response to receiving the media and a second prompt; and a third AI model for generating an animated 3D model of the media in response to receiving the 3D model and a third prompt.

Clause 31: The system of clause 30, further comprising a fourth AI model for updating the first, second, and third prompts and providing the updated prompts to the respective AI models.

Clause 32: The system of any one of clauses 30 through 31, wherein the fourth AI model is a natural language processing (NLP) model configured to update the first, second, and third prompts to define constraints, context, or clarify the respective prompt.

Clause 33: The system of any one of clauses 30 through 32, wherein the fourth AI model performs iterative refinement of prompts, such that the second prompt is updated based on the constraints, context, or clarification defined for the first prompt.

Clause 34: The system of any one of clauses 30 through 33, wherein the fourth AI model updates the first, second, and third prompts without user feedback prior to providing the updated first, second, and third prompts to the respective AI model.

Clause 35: The system of any one of clauses 30 through 34, further comprising a mobile device configured to receive the first, second, and third prompts from a user via a graphical user interface (GUI), the mobile device providing the first, second, and third prompts to the server.

Clause 36: The system of any one of clauses 30 through 35, wherein the GUI of the mobile device is configured to: provide a first graphical element for the user to select the first AI model from a first set of AI models; provide a second graphical element for the user to select the second AI model from a second set of AI models; and provide a third graphical element for the user to select the third AI model from a third set of AI models.

Clause 37: The system of any one of clauses 30 through 36, wherein the first, second, and third sets of AI models are disjoint.

Clause 38: The system of any one of clauses 30 through 37, wherein the server transmits a simulated environment to the mobile device for the mobile device to display the 3D model within the simulated environment.

Clause 39: The system of any one of clauses 30 through 38, wherein the GUI of the mobile device is configured to: provide a rejection element for the user to reject the 3D model provided by the second AI model; and provide an acceptance element for the user to accept the 3D model provided by the second AI model.

Clause 40: The system of any one of clauses 30 through 39, wherein the fourth AI model generates a resubmission prompt based on the updated second prompt and provides the resubmission prompt to one or both of the first and second AI models to regenerate the 3D model in response to selection of the rejection element.

Clause 41: The system of any one of clauses 30 through 40, wherein the third AI model receives the third updated prompt in response to selection of the acceptance element.

Clause 42: The system of any one of clauses 30 through 41, wherein the server transmits the simulated environment to the mobile device for the mobile device to display the animated 3D model within the simulated environment.

Clause 43: The system of any one of clauses 30 through 42, wherein the mobile device is a first mobile device, and the first mobile device transmits one of the 3D model and the animated 3D model to a second mobile device.

Clause 44: The system of any one of clauses 30 through 43, wherein the mobile device is a first mobile device, and the server transmits one of the 3D model and the animated 3D model to a second mobile device.

Clause 45: The system of any one of clauses 30 through 44, wherein the server transmits one of the 3D model and the animated 3D model to both the first and second mobile devices for display within the simulated environment, such that the simulated environment is a shared virtual environment.

Clause 46: The system of any one of clauses 30 through 45, wherein the first or second mobile devices have a synchronized view within the shared virtual environment controlled by one of the first or second mobile devices.

Clause 47: An apparatus or device including a memory comprising executable instructions, and a processor configured to execute the executable instructions and cause the apparatus to perform a method in accordance with any one of clauses 1 through 46.

Clause 48: An apparatus or device, including means for performing a method in accordance with any one of clauses 1 through 46.

Clause 49: A non-transitory computer-readable medium including executable instructions that, when executed by a processor of an apparatus, cause the apparatus to perform a method in accordance with any one of clauses 1 through 46.

Clause 50: A computer program product embodied on a computer-readable storage medium comprising code for performing a method in accordance with any one of clauses 1 through 46.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method comprising:
receiving, by a mobile device, a selection of a media type or a source media;
receiving, by the mobile device, a prompt; and
receiving, by the mobile device, a three-dimensional animation of the selection based on the prompt in response to providing the prompt and selection to one or more generative artificial intelligence (GAI) models.

2. The method of claim 1, wherein the selection is of an image.

3. The method of claim 2, wherein the prompt is a first prompt and the method further comprises receiving an image in response to providing the first prompt and selection of an image to a first GAI model of the one or more GAI models.

4. The method of claim 3, further comprising updating the first prompt to an updated first prompt, the updated first prompt being provided to the first GAI model to generate the image.

5. The method of claim 4, further comprising receiving a second prompt, by the mobile device, and receiving a 3D model in response to providing the second prompt and the image to a second GAI model.

6. The method of claim 5, further comprising providing, by the mobile device, the 3D model in a simulated environment.

7. The method of claim 6, wherein the image is a first image, the method further comprising:
receiving, by the mobile device, a request to regenerate the image;
aggregating the first and second updated prompts into an aggregated prompt;
receiving, by the mobile device, a third prompt; and
receiving, by the mobile device, a second image in response to providing the aggregated prompt and third prompt to the first GAI model.

8. The method of claim 7, wherein the 3D model is a first 3D model, the method further comprising receiving, by the mobile device, a second 3D model in response to providing the aggregated prompt, third prompt, and the second image to the second GAI model.

9. The method of claim 6, further comprising:
receiving, by the mobile device, a third prompt; and
receiving, by the mobile device, an animation of the 3D model in response to providing the 3D model and third prompt to a third GAI model.

10. The method of claim 9, further comprising updating the third prompt to an updated third prompt, the updated third prompt being provided to the third GAI model to generate the animation of the 3D model.

11. The method of claim 10, further comprising providing, by the mobile device, the animated 3D model in the simulated environment.

12. The method of claim 11, wherein the mobile device is a first mobile device, the method further comprising providing, by the first mobile device, the animated 3D model and the simulated environment to a second mobile device.

13. A system comprising:
a server comprising artificial intelligence (AI) models, the AI models comprising;
a first AI model for generating a media in response to receiving a first prompt and a selection of a type of media;
a second AI model for generating a three-dimensional (3D) model of the media in response to receiving the media and a second prompt; and
a third AI model for generating an animated 3D model of the media in response to receiving the 3D model and a third prompt.

14. The system of claim 13, further comprising a fourth AI model for updating the first, second, and third prompts and providing the updated prompts to the respective AI models.

15. The system of claim 14, wherein the fourth AI model performs iterative refinement of prompts, such that the second prompt is updated based on the constraints, context, or clarification defined for the first prompt.

16. The system of claim 13, further comprising a mobile device configured to receive the first, second, and third prompts from a user via a graphical user interface (GUI), the mobile device providing the first, second, and third prompts to the server.

17. The system of claim 16, wherein the server transmits a simulated environment to the mobile device for the mobile device to display the 3D model within the simulated environment.

18. The system of claim 17, wherein the mobile device is a first mobile device, and the server transmits one of the 3D model and the animated 3D model to a second mobile device.

19. The system of claim 18, wherein the server transmits one of the 3D model and the animated 3D model to both the first and second mobile devices for display within the simulated environment, such that the simulated environment is a shared virtual environment.

20. A machine-readable storage medium having stored thereon a computer program, the computer program comprising a routine of set instructions for causing the machine to perform:
receiving, by a mobile device, a selection of a media type or a source media;
receiving, by the mobile device, a prompt; and
receiving, by the mobile device, a three-dimensional animation of the selection based on the prompt in response to providing the prompt and selection to one or more generative artificial intelligence (GAI) models.
